(19) United States
(12) Patent Application Publication
(10) Pub. No.: US 2026/0217294 A1
(43) Pub. Date: Jul. 30, 2026

(54) System and Method to Analyze and Predict Clearance for Transporting Oversized Cargo via Railway or Roadway Transport

(71) Applicant: UTC Overseas, Inc., Houston, TX (US)

(72) Inventor: Marco A. POISLER, Houston, TX (US)

(21) Appl. No.: 19/636,618

(22) Filed: Apr. 1, 2026

Related U.S. Application Data
(63) Continuation-in-part of application No. 19/086,572, filed on Mar. 21, 2025.
Application No. 19/086,572 is a continuation of application No. 18/970,468, filed on Dec. 5, 2024, now Pat. No. 12,296,878.
(60) Provisional application No. 63/709,301, filed on Oct. 18, 2024.
(60) Provisional application No. 63/876,698, filed on Sep. 5, 2025.

(51) Int. Cl. B61L 27/70; B61L 27/57

(52) U.S. Cl. CPC B61L 27/70; B61L 27/57

(57) ABSTRACT

A computing system obtained input data including (i) schematic information associated with a load to be transported and (ii) requirement information associated with transport routes for each of multiple transport modes (i.e., railway and roadway transport modes). Artificial intelligence models determine dimensional parameters of the load based on the schematic information and define, from the dimensional parameters, a transport envelope of the load when carried on a transport for each of the first and second transport modes. For each mode, the models determine a metric that characterizes the transport envelope relative to the route requirement information and generate predictions regarding clearance of the requirements. A dual-mode constraint analysis compares transport modes using the predictions and generate a comparative recommendation, which is then output.

### CROSS-REFERENCE TO RELATED APPLICATIONS

This application is a continuation-in-part of U.S. application Ser. No. 19/086,572 filed Mar. 21, 2025, which is continuation of U.S. application Ser. No. 18/970,468 filed Dec. 5, 2024, which claims the benefit of U.S. Provisional Appl. No. 63/709,301 filed Oct. 18, 2024, each of which is incorporated herein by reference in its entirety. This application also claims the benefit of U.S. Provisional Appl. No. 63/876,698 filed Sep. 5, 2025, which is incorporated herein by reference in its entirety.

### FIELD OF THE DISCLOSURE

The subject matter of the present disclosures relates to artificial intelligence systems used for transportation logistics, specifically to machine learning algorithms that predict the viability of using transport modes (a railway transport mode versus a roadway transport mode) to transport oversized cargo from an origin to a destination by analyzing both clearance constraints alongside regulatory permit requirements. The disclosed subject matter can be used in transportation logistics, freight brokerage, infrastructure planning, and regulatory compliance systems for moving oversized cargo across multiple jurisdictions using transport modes.

### BACKGROUND

Transporting large equipment by rail and truck can be challenging because there can be many physical structures and other obstacles on the railway and highway that need to be physically passed (cleared). Additionally, the route needed to transport the large equipment from a staring location to a final destination may need to pass along many railway lines/highways and different jurisdictions, each having different standards and requirements. The current procedures to determine the route for the transport and to determine if there is sufficient clearance available for the transport can be time-consuming and cumbersome. For example, current transportation planning for oversized cargo relies on manual analysis of route clearances and permit requirements.

Beyond being time-consuming, the manual analysis involves countless variables and alternatives that simply cannot be accounted for or cannot be adequately addressed by an operator. For this reason, operators tend to select an inefficient mode for transporting cargo. Moreover, operators may receive frequent permit denials or may need to modify routes multiple times in an almost trial by error process.

To that end, the subject matter of the present disclosure is directed to improving transportation planning for oversized cargo.

### SUMMARY OF THE DISCLOSURE

One configuration disclosed herein includes a computer-implemented method. In the method, input data is obtained with one or more interfaces in a computing environment. The input data at least includes (i) schematic information associated with a load to be transported, and (ii) requirement information associated with transport routes for each of a plurality of transport modes. A first of the transport modes is different from a second of the transport modes. For example, the first transport mode can be a railway transport mode using railcars to transport a load of oversized cargo on railway routes. The second transport mode can be a road transport mode using trucking arrangements to transport the load on roadway routes.

In the method, one or more artificial intelligence models are operated on one or more processors in the computing environment to perform steps of the method. Dimensional parameters associated with the load are determined based on the schematic information. Based on the dimensional parameters, a transport envelope of the load carried on a transport is defined for each of the first and second transport modes. A metric characterizing the transport envelope in relation to the requirement information associated with the transport routes is determined for each of the first and second transport modes. Based on the metrics, predictions for the transport envelope to clear the requirement information associated with the transport routes are determined for each of the first and second transport modes. Dual-mode constraint analysis is performed comparing the first transport mode versus the second transport mode based on the predictions to generate a comparative recommendation, which is output.

A non-transitory machine-readable medium, on which are stored instructions for a machine, is disclosed herein and comprises instructions that when executed cause the machine to perform the method.

Additionally, a system is disclosed herein and comprises one or more interfaces and one or more processors. The one or more processors are operatively couped to the one or more interface and are configured to obtain input data with the one or more interfaces. The input data at least includes (i) schematic information associated with a load to be transported, and (ii) requirement information associated with transport routes for each of a plurality of transport modes. A first of the transport modes is different from a second of the transport modes. The one or more processors are configured to operate one or more artificial intelligence models to perform the method according to determine dimensional parameters associated with the load based on the schematic information; define, based on the dimensional parameters, a transport envelope of the load carried on a transport for each of the first and second transport modes; determine, for each of the first and second transport modes, a metric characterizing the transport envelope in relation to the requirement information associated with the transport routes; determine, based on the metrics, predictions for the transport envelope to clear the requirement information associated with the transport routes for each of the first and second transport modes; perform dual-mode constraint analysis comparing the first transport mode versus the second transport mode based on the predictions to generate a comparative recommendation; and output the comparative recommendation.

The foregoing summary is not intended to summarize each potential configuration or every aspect of the present disclosure.

### BRIEF DESCRIPTION OF DRAWINGS

FIG. 1 schematically illustrates a computer system for determining a transportation route (e.g., railway route) and obtaining a comparative recommendation to transport an oversized load (e.g., transformer, boiler, pressure vessel, power generator, or other large equipment) via a railway transport mode versus a roadway transport mode.

FIG. 2A illustrates a process for obtaining a comparative recommendation to transport an oversized load (e.g., transformer, boiler, pressure vessel, power generator, or other large equipment) via a railway transport mode versus a roadway transport mode.

FIG. 2B illustrates a process of determining a transportation route (e.g., railway route) and obtaining a clearance report to transport a load (e.g., transformer, boiler, pressure vessel, power generator, or other large equipment).

FIGS. 3A and 3B illustrate representations of image files for use by the disclosed computer system.

FIG. 4 illustrates an example of a maximum clearance profile for a railcar on a railway.

FIG. 5A illustrates an example of a calculated clearance envelope for a railcar and a load.

FIG. 5B illustrates a more detailed example of a calculated clearance envelope for a railcar and a load.

FIGS. 5C-5E illustrate examples of schematic input and calculated clearance envelope for superload trucking arrangements.

FIG. 6 illustrates a graphical user interface for information for the transportation of a load.

FIG. 7 schematically illustrates a convolutional neural network used for analysis by the disclosed system.

FIG. 8 schematically illustrates a training system for training a model according to the present disclosure in an artificial intelligence computing environment.

FIG. 9 illustrates a process for training and deploying a deep neural network for the disclosed computer system.

### DETAILED DESCRIPTION

### A. Computer System

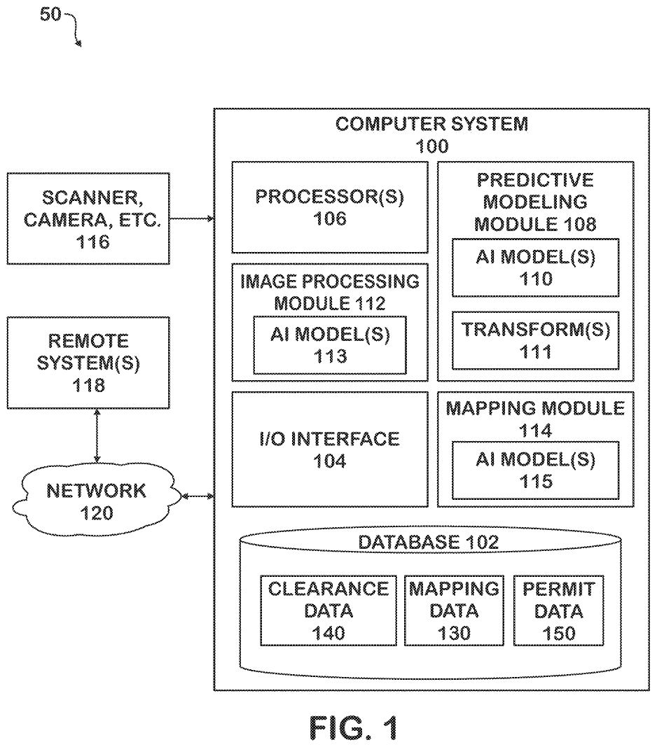

FIG. 1 schematically illustrates a computing environment 50 for determining a transportation route (e.g., railway route/highway route) from an origin to a destination and obtaining a comparative recommendation to transport an oversized load (e.g., transformer, boiler, pressure vessel, power generator, industrial machinery, construction equipment, energy equipment, or other large equipment) via transportation modes. For the purposes of the present disclosure, the transportation modes include a railway transport mode and a roadway transport mode. As will be appreciated, other transport modes can benefit from the present disclosure, such as transport modes using sea vessels and aircrafts.

The computer environment 50 can include different components including, but not limited to, a computer system 100, a database 102, interfaces 104, and a processor 106. Each of these can be comprised of one or more components. The processor 106 is operatively coupled to the database 102 and the interfaces 104.

The computing environment 50 may take different forms. For example, the computer system 100 can be a tablet, a desktop, a laptop, a mobile device, a cloud device, or a standalone device. The computing environment 50 can also be a distributed system that includes one or more connected computing components/devices/servers/clients that are in communication with the computer system. The processor 106 can be, without limitation, different types of hardware logic components/processors, including Field-Programmable Gate Arrays (FPGA), Program-Specific or Application-Specific Integrated Circuits (ASIC), Application-Specific Standard Products (ASSP), System-On-A-Chip Systems (SOC), Complex Programmable Logic Devices (CPLD), Central Processing Units (CPU), Graphical Processing Units (GPU), or any other type of programmable hardware.

Storage provided by the database 102 may be physical system memory, which may be volatile, nonvolatile, or some combination of the two. The term “memory” may also be used herein to refer to nonvolatile mass storage such as physical storage media. If the computer system is distributed, the processing, memory, and/or storage capability may also be distributed. Storage can also include executable instructions (such as code) and data. The code can represent instructions that are executable by one or more processors of the computer system to perform operations.

The I/O interfaces 104 include any type of input or output device. Such devices include, but are not limited to, touch screens, displays, a mouse, a keyboard, a controller, and so forth.

The computer system 100 can communicate over one or more networks 120 with any number of devices or cloud services to obtain or process data in the computing environment 50. The I/O interfaces 104 can therefore include any appropriate network interfaces. In some cases, the one or more networks 120 may be a cloud network. Furthermore, the computer system 100 may also be connected through one or more wired or wireless networks 120 to one or more remote or separate system(s) 118 that are configured to perform any of the processing described in the computing environment 50. The remote systems 118 can include a third-party service that provides artificial intelligence processing, machine learning, and other capabilities, which may be shared with the computer system 100 or may be provided independently.

The remote systems 118 can also include computer systems, databases, and information sources. For example, the remote systems 118 can include railroad information sources, such as for Class 1 and shoreline railroads, and can include roadway information sources. The remote systems 118 can include third-party service providers that have clearance information, route information, schematics of different railroad cars, schematics of different trucking arrangements, and other data relevant to the determinations and calculations disclosed herein for clearance. For example, the remote systems 118 can include clearance measurements from laser scans along railways and highways, measurements of track center along railways, details of critical points (such as bridges, structures, foliage, etc.) along rail lines and highways, successful movement records, and the like.

The computer environment 50 has functional modules for processing input data and for producing output data according to the present disclosure. In particular, the computer environment 50 has one or more artificial intelligence (AI) models, which can be executed on the computer system 100, executed on one or more remote systems 118 and at least utilized by the computer system 100, or both. A first AI model can be trained to determine dimensions from input data, such as image data, and to calculate envelopes from the dimensions. A second model can be trained to find optimal paths along railways and highways, and a third model can be trained to predict clearance based on an analysis of the clearance data, the envelopes, and the optimal paths.

As shown in the example of FIG. 1, the computer system 100 includes a predictive modeling module 108, an image processing module 112, and a mapping module 114. As will be appreciated, the algorithms, data structures, and system architecture of the computer system 100 are only schematically shown in FIG. 1. As will also be appreciated, any of the modules (108, 112, 114) of the computer system 100 can be provided remotely and independently by any of the one or more the remote systems 118. Therefore, in the discussion below, reference to processing performed by the computer system 100 can apply equally to processing performed by any of the one or more remote systems 118 as well.

Looking first at image processing, the image processing module 112 uses one or more AI models 113 trained by machine learning algorithms to learn from image data, determine dimensions from the image data, and calculate envelopes from the dimensions. These one or more AI models 113 of the image processing module 112 can be implemented using appropriate forms of artificial intelligence, such as a deep neural network (DNN), convoluted neural network (CNN), large language model (LLM), and the like.

The image processing module 112 is configured to process image data within a computer-generated image file, a captured image, or other type of image source. For example, the image data can be obtained from an image captured using an imaging device 116, such as a scanner, a camera, etc. Alternatively, the image data can be obtained from a computer-generated image file having a suitable format and being stored in the database 102. For instance, the image processing module 112 can integrate with AutoCAD, Portable Document Format (PDF), or other file formats for computer-generated image files and may use the processing technologies associated with the programs for these types of file formats.

Looking next at mapping, the mapping module 114 includes geospatial mapping capabilities for route analysis. The mapping module 114 can use one or more AI models 115 trained by machine learning algorithms to learn from mapping data, determine logistic information, and find optimal paths along railways and highways. These one or more AI models 115 of the mapping module 114 can be implemented using appropriate forms of artificial intelligence, such as a deep neural network (DNN), convoluted neural network (CNN), large language model (LLM), and the like.

The database 102 stores mapping data 130 and historical clearance data 140 for the railways and highways. The database 102 can also store specifications and other appropriate information for railcars and for trucking arrangements (e.g., trucks, trailers, etc.). The mapping data 130 and the historical clearance data 140 can be obtained from external data sources and remote systems 118, such as transportation agencies (North American Rail Network, Federal Railroad Administration, Association of American Railroads (AAR) Open Top Loading Rules, American Railway Engineering and Maintenance-of-Way Association (AREMA), etc.), railroad companies (BNSF, Union Pacific, Kansas City Southern, CSX, Norfolk Southern, etc.), Departments of Transportation for States, Federal Highway Administration, U.S. Department of Transportation Administrations, and the like. Guidelines can also be obtained from sources, such as tie down requirements according to AREMA Committee 28 and the AAR Open Top rules.

In this way, physical route clearance of a load on a railcar or a trucking arrangement for a route can be further refined according to a Tie Down clearance or other rules governing the load on the railcar or trucking arrangement after inspection. The computer system 100 can access these types of guidelines for specific implementations. Due to the amount of data involved, the extent of the rail network (i.e., over 160,000 miles), and the extent of the U.S. highway network (i.e., approximately 4.2 million miles of navigable roadways and 47,432 miles of Interstate highway), the underlying storage of the mapping data 130 and the historical clearance data 140 may be remote from the computer system 100, and the computer system 100 may interface with remote systems 118 to obtain discrete amounts of data for processing and predictive analysis for a given project. The database 102 can also include permit data 150, which is pertinent to analyzing and obtaining permits for the roadway transport mode. Further details related to permitting are discussed below.

Additionally, the computer system 100 can receive information from remote systems 118, such as engineering standards of minimum operating clearances from Class 1 railroads, the national highway system, or other sources. The information can include schematic image files or textual guidelines giving minimum clearances values and outlines. For the railway transport, the information can be for through railroad owned structures and facilities, such as structures (poles) supporting wirelines, watering and fueling columns, signs, instrument case, dwarf signals between tracks, switch stands, switch machines, platforms, docks, tunnels, bridges, bridge handrails, cattle guards, railroad shops and servicing facilities, overhead structures, electrified territory, stored material, and the like. These may usually be given in terms of minimum clearance values relative to the centerline of the track. Each railroad, such as Class 1 railroads, may also have guidelines requiring clearances to be increased laterally on each side by a given increment for each degree of curvature in the rail when a structure is situated on the curve. Similar information can be available for truck transport on highways.

The mapping data 130 includes the geographical details of interconnected railway and roadway networks in one or more geographic areas so routes can be analyzed for transportation of an oversized load on a rail car or a trucking arrangement from an origin to a destination. Other than the route information of the railway and roadway networks, the mapping data 130 can include railroad network nodes, rail yards, intermodal freight facilities, freight stations, grade crossings, mileposts, etc., as well as comparable details for roadway networks. The mapping data 130 includes information of possible railway and roadway paths, including the length of tracks/roads, junctions, intersections, and connections between different railways/roadways.

The historical clearance data 140 can include laser scans, track center measurements, and spatial measurements of obstacles along railways and roadways. These obstacles tend to include manmade structures (tunnels heights, signage, utility poles, signal masts, bridge height clearances, walls, fence, overpass, track center from adjacent tracks, structures, etc.). For example, through-truss bridges on railways have angled wing braces and widths that can limit the size of loads carried on railcars that can pass over the bridge. Even a through-plate girder bridge for rail can present an obstacle for low deck flatcars. The obstacles can also include natural structures (cliff sides, canyon walls, trees, etc.). The clearances for both manmade and natural structures along the rail and roadways can change over time due to construction, track shifting, maintenance, etc. Accordingly, the historical clearance data 140 can be measured and updated over time.

Finally, looking at prediction, the predictive modeling module 108 uses one or more Artificial Intelligence (AI) models 110 as trained artifacts created by machine learning algorithms. (As noted, one or more AI models 110 can be used, but reference may be made to one such model for the purposes of discussion.) In general, the AI model 110 as disclosed herein can include a neural network (e.g., a deep neural network, a convolutional neural network for image recognition, a Feedforward neural networks used in predictive modeling, etc.), a decision tree, a support vector machine, and the like.

The AI model 110 is capable of making classifications, decisions, and predictions based on input data. To do this, the AI model 110 encapsulates learned patterns and uses the learned patterns to solve the image recognition, calculations, predictions, and other determinations disclosed herein. For example, the AI model 110 can predict clearance based on an analysis of the historical clearance data, the envelopes, and the optimal paths. The AI model 110 can calculate clearance probabilities for a railway transport mode versus a roadway transport mode and can provide a comparative recommendation. In its simplest form, the comparative recommendation may include a recommendation of one transport mode over another transport mode, along with all of the required information to configure and execute the transport. Other forms are possible, for example, the comparative recommendation may include a recommendation that includes a combination of the transport modes, including any one or more connected segments thereof and all of the required information to configure and execute the transport.

The predictive modeling module 108 can also use one or more transforms 111 to perform data preprocessing to modify raw data into a format suitable for use by the AI model 110. (As noted, one or more transforms 111 can be used, but reference may be made to one such transform for the purposes of discussion.) The transform 110 can scale, normalize, or otherwise optimize the input data for the AI model 110. For example, the transform 111 can convert categorical variables into one vector in a process of hot encoding, and numerical data can be scaled to specific ranges. Therefore, in the machine learning (ML) pipeline of the present disclosure, the transform 111 can prepare input data, and the AI model 110 can perform the tasks associated with the present disclosure.

In particular, the predictive modeling module 108 uses the AI model 110 to perform predictive modeling. To do this, the AI model 110 uses one or more machine learning algorithms to learn from data and make predictions. These one or more machine learning algorithms of the AI model 110 can be implemented using appropriate forms of artificial intelligence, such as a deep neural network (DNN), convoluted neural network (CNN), large language model (LLM), and the like. The AI model 110 may be implemented as a specific processing unit (e.g., a dedicated processing unit) configured to perform one or more specialized operations for the computer system 100 or configured to perform any of the disclosed method acts or other functionalities.

### B. Comparative Process

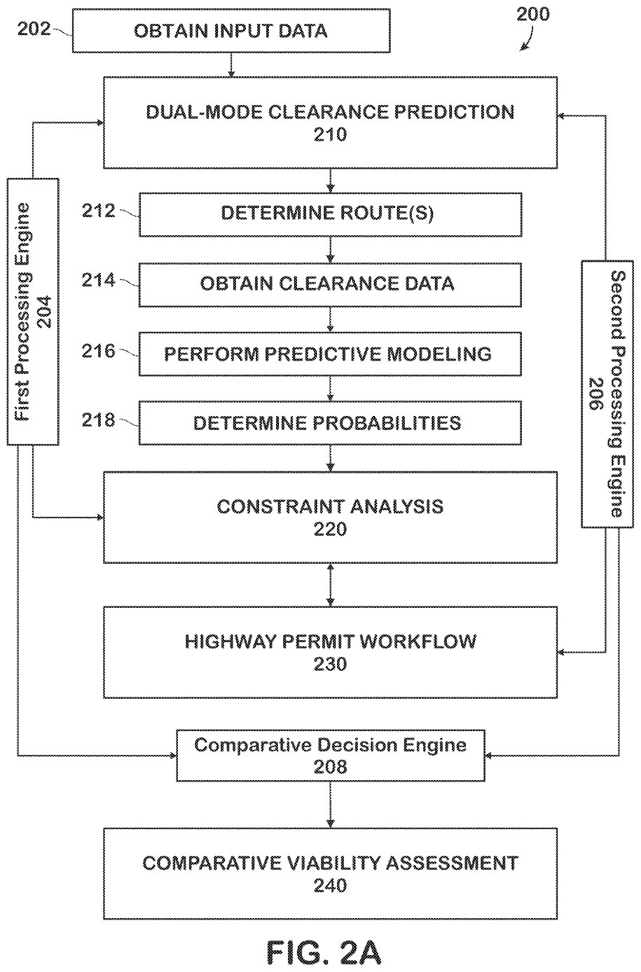

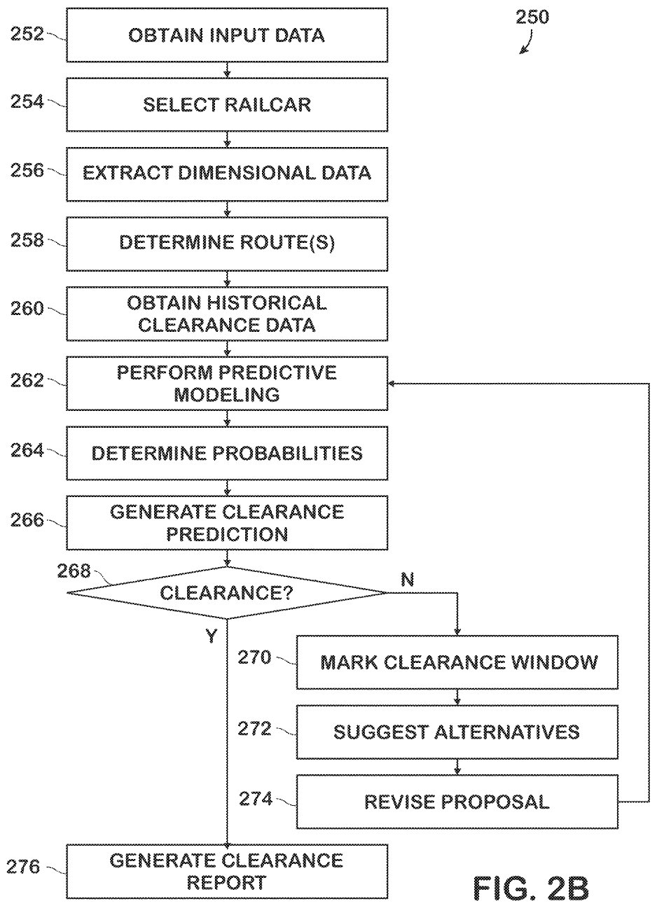

Having an overview of the computing environment 50, discussion now turns to FIG. 2A, which illustrates a process 200 of determining a transportation route (e.g., railway route/roadway route) and obtaining a comparative recommendation to transport an oversized load (e.g., transformer, boiler, pressure vessel, power generator, or other large equipment). For better understanding, reference is concurrently made to features of the computer environment 50 in FIG. 1 as well as to features in other figures disclosed herein.

The AI-based system of the computing environment 50 predicts the viability of using a railway transport mode versus a roadway transport mode to transport a load of oversized cargo from an origin to a destination by using four stages: (1) Dual-Mode Clearance Prediction (Block 210), (2) Constraint Analysis (Block 220), (3) Highway Permit Workflow (Block 230), and (4) Comparative Viability Assessment (Block 240).

First, the four stages are briefly described. The process 200 produces a “digital twin”—i.e., a digital representation of the transport infrastructure and transport equipment for the transport modes (railway/roadway). The transport infrastructure has specific limitations and requirements, and the transport equipment including the load and the transport (e.g., railcar or trailer) has specific dimensions and other parameters. The digital twin is used for AI-driven predictive interactions to simulate and determine the feasibility of the transport carrying the load to clear the infrastructure for the two transport (railway/roadway) modes. Using the digital twin, for example, the process 200 can continuously update the modeling, can use bidirectional data flows between physical operations and a simulation environment, and can perform real-time refinements of clearance predictions based on operational feedback. To do this, the disclosed process 200 performs predictive modeling and AI-based simulation to generate clearance envelopes. From the clearance envelopes, the disclosed process 200 calculates probabilistic outcomes and determines the feasibility of using given transport routes based on physical dimensional constraints and historical data.

Using dual-mode clearance prediction (Block 210), for example, the disclosed process 200 analyzes both rail loading gauge profiles and highway bridge clearance envelopes to predict clearances for the oversized cargo load in both the railway transport mode and the roadway transport mode. For the railway transport mode, the disclosed process 200 also analyzes the constraints of the rail infrastructure for the transport of the oversized cargo load (Block 220). The analysis incorporates constraints, including track gauge restrictions, overhead clearances, and loading dock limitations. For the roadway transport mode, the process 200 includes a workflow to determine highway permits for the transport of the oversized cargo load (Block 230). The workflow processes truck permit requirements, escort specifications, and routing restrictions.

Finally, using the previous analysis results, the disclosed process 200 performs a comparative assessment of the viability of using the railway transport mode versus the roadway transport mode for the oversized cargo load (Block 240). The comparative assessment generates recommendations by modeling and satisfying the respective constraints for the transport modes. In its simplest form, the comparative assessment compares two transport modes (e.g., just railway and roadway transport modes), and the comparative recommendation may include a recommendation of one transport mode over another transport mode, along with all of the required information to configure and execute the transport. Other forms of assessment and recommendation are possible. The comparative assessment may compare more than two different transport modes (i.e., more than just railway and roadway transport modes). The comparative assessment may compare more than one given instance of the same transport mode, such as the same transport mode using one type of transport (e.g., a first railcar type) and another type of transport (e.g., a second railcar type). Moreover, the comparative recommendation may include a recommendation that includes a combination of the transport modes, including any one or more connected segments of those transport modes and all of the required information to configure and execute the transport.

### 1. Clearance Prediction

Looking now at the four stages in more detail, the architecture of the disclosed process 200 employs a multi-stage constraint satisfaction approach rather than traditional classification. In the architecture's dual-mode clearance prediction (Block 210), the disclosed process 200 performs a railway clearance prediction for transporting the oversized cargo load using the railway transport mode. In the first stage, the disclosed process 200 also performs a roadway clearance prediction for transporting the oversized cargo load using the roadway transport mode.

In particular, the dual-mode clearance prediction (Block 210) can use a clearance prediction system discussed below and disclosed in the incorporated patent applications (Ser. No. 19/086,572; 18/970,468; and 63/709,301), which determines the feasibility of transporting the oversized cargo load using given transports (e.g., railcar or trailer) on the railway and roadway routes. To do this, the clearance prediction system uses AI models, historical clearance data, and predictive modeling to generate clearance reports. Features of this clearance prediction system can be used for both the railway transport mode and the roadway transport mode. Some of the steps associated with dual-mode clearance prediction (Block 210) include determining routes for the transport (Block 210), obtaining clearance data (Block 214), performing predictive modeling (Block 216), and determining probabilities (Block 218).

Using features of the clearance prediction system noted above for both the railway transport mode and the roadway transport mode, the process 200 according to the present disclosure then performs comparative analysis between the alternative transport modes, such as the railway transport mode versus the roadway transport mode (Block 240). Additionally, the process 200 according to the present disclosure integrates a workflow to meet truck permit requirements and to provide multi-modal transport recommendations (Block 230).

a. Clearance Prediction for Railway Transport Mode

With respect to the railway transport mode, the dual-mode clearance prediction (Block 210) obtains input data (Block 212). For example, the input data at least includes (i) mapping data for railways, (ii) historical clearance data for the railways, and (iii) schematic data at least associated with an oversized cargo load to be transported. The input data can also include (iv) an origin and a destination for transport of the oversized cargo load carried on a railcar. The input data includes parameters, such as dimensions of the oversized cargo load (cargo_dimensions), rail clearance data, and rail loading gauge profile for one or more route segments for the route to transport the oversized cargo load from an origin to a designation (rail_loading_gauge_profile [route_segment]).

To obtain the input data, the processor 106 can access the mapping data 130 and the historical clearance data 140 from storage in the database 102 or from a remote system 118, such as a cloud storage or an enterprise system. Also, the mapping data 130 can include information about rail networks information in one or more geographical locations. As also noted, the historical clearance data 140 can include clearance measurements made along the various rail network routes in one or more geographical locations. For example, various clearance measurements may be periodically made and updated along railroad routes. For instance, laser measuring devices (e.g., LiDAR distance laser) mounted on a vehicle riding along the rail track can be used to make the measurements. Railways also often make measurements of track centers and curves and maintain that data.

The input data may already include a transport to be used to transport the load. For the railway transport mode, the transport can be a railcar or an arrangement of railcars. For example, this information may be contained in schematic data input into the computer system 100. In other instances, schematic data of only the oversized cargo load may be provided as input into the computer system 100. Accordingly, the computer system 100 can store transport information of selectable transports and can allow a user to select a selectable transport (railcar to be used to transport the oversized cargo load. The selection can be a user-based selection received by a user in a graphical user interface.

From the input data, the computer system 100 now extracts dimensional data. In particular, when the input data includes schematic image data, the image processing module 112 processes the schematic image data of at least the oversized cargo load, may process separate schematic image data of the transport and the oversize cargo load, and may perform other processing discussed below. Based on the processed data, the computer system 100 determines dimensional parameters associated with the load carried on the transport (e.g., railcar. In turn, based on the dimensional parameters, the image processing module 112 defines a transport envelope of the load carried on the transport (e.g., railcar.

With this set up of processed input data, parameters, and transport envelope, the mapping module 114 operates a machine learning algorithm to determine the railway networks connecting between the origin and the destination. The rail system in North America is comprehensive and interconnected, and States have few restrictions for moving large loads by rail. As expected, one or more railroad routes over one or more portions of railway networks may be accessible to transport from the origin (O) to the destination (D). The mapping module 114 identifies any of the one or more relevant railroad routes that are accessible.

For example, the mapping module 114 can determine the railway networks connected between the origin and the destination by: discovering any one or more sections of any one or more of the railway networks being interconnected to one another between the origin and the destination; and outlining any one or more routes along the any one or more sections connecting the origin to the destination.

At this stage of the dual mode clearance prediction (Block 210), the predictive modeling module 108 obtains the historical clearance data 140 for the determined route(s) (Block 212). Some of the relevant historical clearance data 140 may be stored in the database 102, and some may be accessed from a remote system 118.

Using the one or more determined route(s), the dimensional parameters, and the historical clearance data, the AI model 110 of the predictive modeling module 108 probabilities, confidence intervals, pass-fail scores, tabulated numbers of critical points, etc.) for clearance of the load carried by the railcar transport (e.g., railcar) along the determined route(s) (Block 218). The predictive results can in general include one or more metrics characterizing the transport envelope of the load carried on the railcar clearing the historical clearance data on the one or more railway routes. As its goal, predictive modeling module 108 seeks to calculate a probability value, a confidence interval, a pass-fail score, a tabulated number of critical points, or other numerical metric of securing suitable clearance along the one or more identified routes. For example, using the AI model 110, the predictive modeling module 108 determines probabilities or other metrics characterizing the transport envelope of the load carried on the railcar clearing obstacles in the historical clearance data on the determined route(s) of the railway network(s). The calculations can use dynamic adjustment factors, safety margins, and accuracy metrics. The analysis for the clearance may also use calculations for any speed restrictions in passing critical points along the railway route. Because the required processing may be intensive, the computer system 100 can use dedicated and/or remote resources to perform the analysis, such as provided by a remote system 118.

Thus, in the rail clearance prediction for the railway transport mode, for example, if the cargo dimensions of the load exceed the rail loading gauge profile for a given route segment, then the dual-mode clearance prediction (Block 210) detects a rail clearance violation and then calculates what modifications to the rail requirements would be needed for the transport of the oversized cargo load (calculated_rail_modification_requirements). After this evaluation, the dual-mode clearance prediction (Block 210) generates rail clearance results for the railway transport mode of the oversized cargo load via one or more routes from the origin to the destination. In a similar example for the roadway transport mode, the cargo dimensions of the load, its weight, or the like can exceed limitations for a given route segment, and the dual-mode clearance prediction (Block 210) can detect a roadway clearance violation and can calculate what modifications would be needed for the transport of the oversized cargo load.

b. Clearance Analysis for Roadway Transport Mode

As noted above, the dual-mode clearance prediction (Block 210) also performs a roadway clearance prediction for transporting the oversized cargo load using a trucking transport in the roadway transport mode. This can be similar to the predictions made with respect to the railway transport mode described above.

Briefly, the dual-mode clearance prediction (Block 210) obtains various parameters, including the dimensions of the oversized cargo load, bridge clearance date for one or more roadway routes between the origin and designation (Block 202). The dual-mode clearance prediction (Block 210) determines routes for the transport (Block 212), obtains clearance data (Block 214), performs predictive modeling (Block 216), and determines probabilities (Block 218).

With respect to the roadway transport mode, the dual-mode clearance prediction (Block 210) obtains input data (Block 212). For example, the input data at least includes (i) mapping data for roadways, (ii) historical clearance data for the roadway, and (iii) schematic data at least associated with an oversized cargo load to be transported. The input data can also include (iv) an origin and a destination for transport of the oversized cargo load carried on a trucking transport. The input data includes parameters, such as dimensions of the oversized cargo load, roadway clearance data, and roadway limitations for one or more route segments for the route to transport the oversized cargo load from an origin to a designation.

To obtain the input data, the processor 106 can access the mapping data 130 and the historical clearance data 140 from storage in the database 102 or from a remote system 118, such as a cloud storage or an enterprise system. Also, the mapping data 130 can include information about road networks in one or more geographical locations. As also noted, the historical clearance data 140 can include clearance measurements made along the various road network routes in one or more geographical locations. For example, various clearance measurements may be periodically made and updated along roadway routes. Comparable measurements and information available for railway can be available for roadways, such as interstate highways and the like.

The input data may already include a transport to be used to transport the load. For the roadway transport mode, the transport can be a trucking arrangement. For example, this information may be contained in schematic data input into the computer system 100. In other instances, schematic data of only the oversized cargo load may be provided as input into the computer system 100. Accordingly, the computer system 100 can store transport information of selectable transports and can allow a user to select a selectable transport (railcar or trailer) to be used to transport the oversized cargo load. The selection can be a user-based selection received by a user in a graphical user interface.

From the input data, the computer system 100 now extracts dimensional data. In particular, when the input data includes schematic image data, the image processing module 112 processes the schematic image data of at least the oversized cargo load, may process separate schematic image data of the transport and the oversize cargo load, and may perform other processing discussed below. Based on the processed data, the computer system 100 determines dimensional parameters associated with the load carried on the transport (e.g., trailer). In turn, based on the dimensional parameters, the image processing module 112 defines a transport envelope of the load carried on the transport (e.g., trailer).

With this set up of processed input data, parameters, and transport envelope, the mapping module 114 operates a machine learning algorithm to determine the roadway networks connecting between the origin and the destination. Comparable determinations made for the railway networks can be made for the roadway networks.

For example, the mapping module 114 can determine the roadway networks connected between the origin and the destination by: discovering any one or more sections of any one or more of the roadway networks being interconnected to one another between the origin and the destination; and outlining any one or more routes along the any one or more sections connecting the origin to the destination.

At this stage of the dual mode clearance prediction (Block 210), the predictive modeling module 108 obtains the historical clearance data 140 for the determined route(s) (Block 212). Some of the relevant historical clearance data 140 may be stored in the database 102, and some may be accessed from a remote system 118.

Using the one or more determined route(s), the dimensional parameters, and the historical clearance data, the AI model 110 of the predictive modeling module 108 probabilities, confidence intervals, pass-fail scores, tabulated numbers of critical points, etc.) for clearance of the load carried by the transport (e.g., trailer) along the determined route(s) (Block 218). The predictive results can in general include one or more metrics characterizing the transport envelope of the load carried on the transport clearing the historical clearance data on the one or more transport routes.

As its goal, predictive modeling module 108 seeks to calculate a probability value, a confidence interval, a pass-fail score, a tabulated number of critical points, or other numerical metric of securing suitable clearance along the one or more identified routes. For example, using the AI model 110, the predictive modeling module 108 determines probabilities or other metrics characterizing the transport envelope of the load carried on the transport clearing obstacles in the historical clearance data on the determined route(s) of the roadway network(s). The calculations can use dynamic adjustment factors, safety margins, and accuracy metrics. The analysis for the clearance may also use calculations for any speed restrictions in passing critical points along the railway route. Because the required processing may be intensive, the computer system 100 can use dedicated and/or remote resources to perform the analysis, such as provided by a remote system 118.

Thus, in the clearance prediction for the roadway transport mode, the cargo dimensions of the load, its weight, or the like can exceed limitations for a given route segment. For example, the oversized cargo load's height on the transport trailer can be greater than the minimum bridge clearance for given highway routes. The dual-mode clearance prediction (Block 210) can detect a roadway clearance violation and can calculate what modifications would be needed for the transport of the oversized cargo load. With the clearance violation, for example, the disclosed process 200 can calculate what escort permits would be required for the transport of the oversized cargo load (calculated_permit_escort_requirements). After this evaluation, the dual-mode clearance prediction (Block 210) generates rail clearance results for the railway transport mode of the oversized cargo load via one or more routes from the origin to the destination.

In the integrated railway-roadway clearance analysis of the first stage, the dual-mode clearance prediction (Block 210) provides simultaneous analysis of both rail loading gauge profiles and highway bridge clearance envelopes, which enables a direct comparison between the railway and roadway transport modes for identical cargo specifications.

### 2. Constraint Analysis

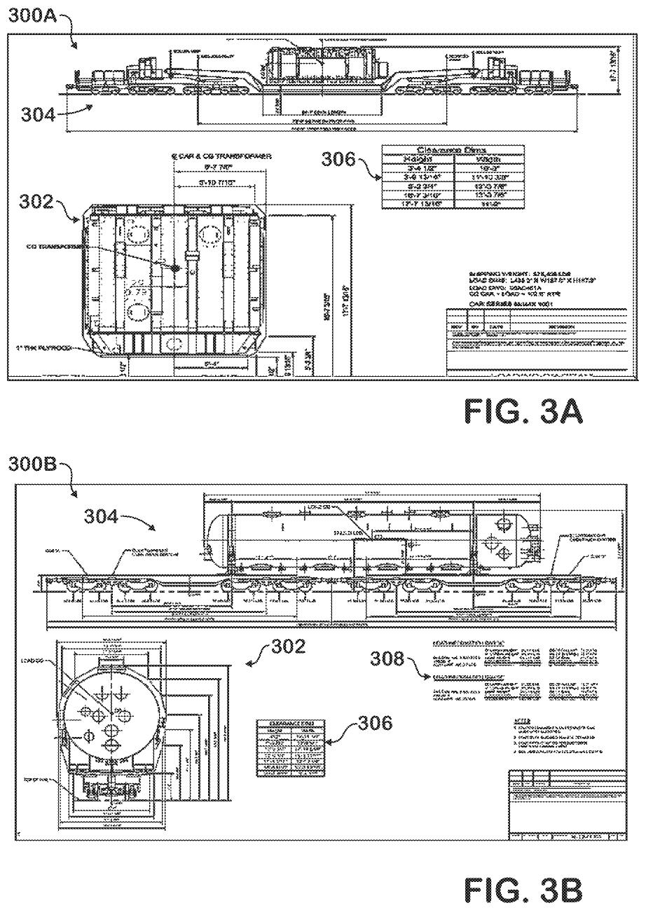

In the architecture's second stage for the constraint analysis (Block 220), the disclosed process 200 evaluates rail-specific constraints, including loading gauge compliance, track gauge restriction, intermodal facility constraints, and rail bridge clearances. Evaluating loading gauge compliance, the disclosed process 200 checks the envelope (see e.g., FIGS. 3A-3B) of the oversized cargo load against Association of American Railroad (AAR) Plate specifications and railroad-specific clearance profiles. Evaluating the track gauge restrictions, the disclosed process 200 validates the compatibility of one or more railcars that can be used to transport the oversized cargo load across different rail networks (e.g., standard gauge, narrow gauge). Evaluating the intermodal facility constraints, the disclosed process 200 analyzes crane capacity, track access, and loading dock dimensions at origin/destination terminals for the transport of the oversized cargo load. Finally, evaluating rail bridge clearances, the disclosed process 200 processes overhead clearances, including catenary systems and signal bridges. After this evaluation, the disclosed process 200 has generated results that satisfy the rail constraints for the railway transport mode of the oversized cargo load via one or more routes from the origin to the destination.

### 3. Permit Workflow

In the architecture's third stage (Block 230), the disclosed process 200 analyzes truck permitting requirements for transporting the oversized cargo load via one or more routes from the origin to the destination. As will be appreciated, oversized load transport can require significant planning prior to applying for any permits. The analysis performed here facilitates this process and involves dimensional qualification, escort calculation, route restriction analysis, and safety equipment requirements. In the dimensional qualification, the disclosed process 200 applies qualification rules from the requisite permit handbook for cargo that is overweight, overwidth, overlength, and overheight. The escort calculation generates escort requirements based on thresholds for cargo widths and route classifications. The route restriction analysis processes time-of-travel limitations, holiday restrictions, and urban area constraints. Finally, for safety equipment requirements, the discloses system calculates amber lighting, banner, and flagging specifications. After this analysis, the disclosed process 200 has generated results that satisfy the truck constraints for the roadway transport mode of the oversized cargo load via one or more routes from the origin to the destination.

In the comprehensive permit workflow of the third stage (Block 230), the disclosed process 200 automates the workflow to obtain truck permits by assessing dimensional qualifications, calculating escort requirements, generating safety equipment specifications, and determining multi-jurisdictional permits as disclosed in transportation permit regulations.

### 4. Recommendation

In the multi-modal constraint satisfaction of the second stage (Block 220) and the third stage (Block 230), the disclosed process 200 analyzes the constraints to determine factors that satisfy the constraints by evaluating rail infrastructure limitations (Block 220) and highway permit requirements (Block 230) concurrently. This eliminates infeasible transport options through hierarchical constraint evaluation before applying probabilistic analysis.

The fourth stage (Block 240) uses a comparative transport mode recommendation engine to generate explicit recommendations for the railway transport mode versus the roadway transport mode. The engine performs multi-criteria decision analysis, weighing rail infrastructure compatibility against highway permit approval probability and regulatory compliance requirements. To do this, the engine includes machine learning components.

For the transport comparison, the process 200 performs comparative analysis based on (i) the clearance analysis for railway transport as one half of the equation to evaluate the feasibility of using railway transport for the load and (ii) the clearance analysis for roadway transport as the other half of the equation to evaluate the feasibility of using roadway transport for the load. Ultimately, the process 200 performs viability scoring for comparing the two transport modes and generates a comparative recommendation on the optimal transport mode based on multi-criteria scoring, including infrastructure compatibility, regulatory constraints, cost, and schedule.

As noted above, a first processing engine 204 performs the clearance prediction (Block 210) and constraint analysis (Block 220) for the rail infrastructure to determine feasibility of the railway transport mode to transport the oversized cargo load from the origin to the destination. In loading gauge validation, for example, the first processing engine processes cargo dimensions against AAR Plate C specifications and railroad-specific clearance profiles, building on techniques disclosed in the incorporated U.S. patent applications (Ser. No. 19/086,572; 18/970,468; and 63/709,301) for rail clearance prediction. In track infrastructure assessment, for example, the first processing engine evaluates track gauge compatibility, catenary clearances, and intermodal terminal capabilities. In historical rail clearance integration, the first processing engine uses historical railway clearance data and predictive modeling methods similar to those described in rail-specific systems disclosed in the incorporated U.S. patent applications (Ser. No. 19/086,572; 18/970,468; and 63/709,301). Finally, for rail route optimization, the first processing engine determines optimal railway routes considering infrastructure constraints and terminal accessibility.

As noted above, a second processing engine 206 performs the clearance prediction and permit processing in the roadway clearance prediction (Block 210) and the permit workflow (Block 230). An input layer receives input data, including cargo specifications, highway route data, and permit requirements. Clearance analysis validates that the input data satisfies bridge height and meets width restrictions. At this point, an automated permit workflow calculates escort requirements and safety equipment specifications. The second processing engine ultimately outputs a probability value characterizing the viability of using the roadway transport mode for the transport of the oversized load from the origin to the destination probability and outputs a likelihood of permit approval for the roadway transport mode.

Using the outputs from these processing engines 204 and 206, a comparative decision engine 208 now performs multi-criteria analysis to determine recommendations for the railway transport mode versus the roadway transport mode (Block 240). The comparative decision engine 208 can perform a classification task, selecting which mode of transport has the highest predicted probability. For the comparison, a rail viability score (rail_viability_score) is calculated. The rail viability score characterizes the viability of using the railway transport mode. A rail clearance probability (rail_clearance_probability) is used to calcite the rail viability score. The rail clearance probability characterizes the probability that the oversized cargo load in the rail transport will satisfy the requisite rail clearances. A rail infrastructure compatibility (rail_infrastructure_compatibility) is also used to calculate the rail viability score. The rail infrastructure compatibility characterizes how compatible the oversized cargo load is to the constraints of the rail infrastructure. The calculation can be as follows:

$$rail\_viability \_score = rail\_clearance \_probability \times rail\_infrastructure \_compatibility .$$

For the comparison, a truck viability score (truck_viability_score) is also calculated. The truck viability score characterizes the viability of using the roadway transport mode. A highway clearance probability (highway_clearance_probability) is used to calculate the truck viability score. The rail clearance probability characterizes the probability that the oversized cargo load in the truck transport will satisfy the requisite highway clearances. A permit approval probability (permit_approval_probability) is also used to calculate the truck viability score. The permit approval probability characterizes the probability that the truck transport of the oversized cargo load will achieve permit approval. The calculation can be as follows:

$$truck\_viability \_score = highway\_clearance \_probability \times permit\_approval \_probability$$

The comparative decision engine 208 then uses the rail viability score and the truck viability score to provide a transport recommendation, which characterizes which mode of transport is best suited for the transport of the oversized cargo load from the origin to the destination. The transport recommendation can be calculated as: transport_recommendation=argmax (rail_viability_score, truck_viability_score). As can be seen above, the arg max function selects the higher score in the dataset of the rail viability score and truck viability score.

### C. Summary

In summary, the disclosed system 100 and process 200 uses a data processing pipeline to obtain and process input data to provide the output data. In particular, the disclosed system 100 and process 200 can communicate in real-time with (or can be integrated in real-time into) systems and databases for railway and trucking transport. For example, the disclosed system 100 and process 200 can communicate with bridge condition monitoring systems, seasonal restriction databases, construction zone impact analysis, weight posting modification tracking, etc.

The disclosed system 100 and process 200 processes cargo specifications in an automated fashion. For example, the disclosed system 100 and process 200 can perform computer vision analysis of equipment drawings for the oversized cargo load, railcars, trucking arrangements, and the like. Three-dimensional models can be generated from specification documents. The load distribution can be calculated from weight specifications, and the center of gravity can be estimated.

Additionally, a permit analysis engine performs the workflow for truck permitting. The permit analysis engine automates the workflow for applying for and obtaining permits as disclosed in transportation permit handbooks. As noted above, the permit workflow assesses dimensional qualifications. For overweight permit qualification, single item/commodity analysis is performed to prevent multiple item combinations. Logic for an overwidth permit can determine whether linear loading can be used instead of side-by-side loading, which may be prohibited beyond a legal width (e.g., 8 ft. 6 in.). For an overlength permit, an evaluation can determine whether a continuous length commodity can be used when there are route-dependent length limits. For an overheight permit, an evaluation can determine whether a single item height can meet a legal height limit (e.g., 14 ft.) when there is a stacking prohibition.

Given the diverse types of permits involved, the permit analysis engine selects the appropriate permit type for the oversized cargo load. The selection can be based on various factors, including specifications (e.g., width, etc.) of the cargo load, frequency of the route for the cargo load, whether the cargo load qualifies for an annual permit, whether the cargo load is being transported from a manufacturer to a dealer, whether a single trip is being performed, etc.)

For example, if the cargo load qualifies for an annual permit based on the cargo specifications and route frequency, the engine can recommend an annual permit when the cargo width is less than or equal to 12 feet and the route is in an approved network. If the cargo load qualifies for an annual permit based on the cargo specifications and route frequency, the engine can evaluate eligibility for a blanket permit when the cargo width is less than or equal to 16 feet and the route is from a manufacturer to a dealer. Otherwise, the engine will process the requirements for a single trip permit.

As noted above, an escort requirement calculation is made during processing and analysis. The calculation processes width-based escort requirements per regulatory specifications. Some examples include a requirement for flags only for widths of 8′7″ to 10′; a requirement for flags and “WIDE LOAD” banners front/rear for widths of 10′1″ to 12′; all the previous requirements and one escort vehicle for widths of 12′1″ to 14′; all the previous requirements and dual escort (two escorts on two-lane highways) for widths of 14′1″ to 15′; and route-specific analysis with enhanced escort protocols for widths of 15′+.

As noted above, safety equipment requirements are automatically generated. The automated equipment requirements are based on cargo specifications, which can include, for example, a requirement for amber flashing lights (500′ visibility, 360° coverage); banner specifications (7′×18″ with 10″ lettering, 1.5″ brush strokes); height pole indicator requirements for loads exceeding 14′5″; and two-way radio communication mandates between transport and escorts.

As noted above, time/route restrictions are considered in the analysis. These restrictions can include, for example, holiday travel restrictions for loads >112,000 lbs or exceeding dimensional limits; sunrise-to-sunset travel limitations with cargo-specific variations; urban area restrictions (10-mile radius limitations around major cities during peak hours); and weather condition constraints (25 mph wind limits for mobile homes >10′ width).

As noted above, multi-jurisdictional permitting is considered in the analysis. In a cascading fashion, a model determines dependencies of permit approvals across state boundaries. A total probability of obtaining a permit is determined based on the probability of obtaining a permit in each given state of the route and an approval factor for the route.

A prediction of permit fees can also be integrated into the analysis. Some examples of permit fees predictions include: a predicted cost for an annual permit fee for various loads (e.g., general commodities, mobile homes, etc.); a predicted cost for a single trip permit fee that can have base fee and weight-based surcharges; and a predicted cost for a superload permit fee that can have non-refundable fee and additional costs per weight over a given amount).

The disclosed system 100 and process 200 can use feedback and outcome tracking to refine the analysis of the disclosed system 100 in the future. In general, actual transport successes and failures as well as permit approvals and denials can be monitored. Field surveys can verify accuracy of route constraints. In the end, accuracy of the disclosed system's models can be assessed and recalibrated.

In contrast to existing systems that fail to integrate real-time infrastructure data with predictive modeling for constraint satisfaction across multiple transport modes, the disclosed system 100 and process 200 proactively integrate real-time infrastructure data with predictive modeling for constraint satisfaction across multiple transport modes. Accordingly, the disclosed system 100 and process 200 provide a number of technical advantages over existing techniques. The approach of satisfying constraints eliminates impossible options early, focusing prediction on viable alternatives. Adapting in real-time, the dynamic infrastructure integration provides current constraint conditions. Analysis based on historical precedents improves permit approval predictions. Geometric precision using the three-dimensional modeling accounts for complex cargo shapes and orientation effects. The disclosed system 100 and process 200 have a scalable architecture that allows integration with existing transportation management systems.

The disclosed system 100 and process 200 have to account for numerous complex factors in making predictions and recommendations based on input data. To name a few, these complex factors at least include: the extensive network of railway and roadway routes and various alternatives that can be used to transport an oversized load; the various types of transports that can be used to transport the oversized load’ the numerous possible interactions between the oversized load with different obstacles (tunnels heights, signage, utility poles, signal masts, bridge height clearances, walls, fence, overpass, track center from adjacent tracks, structures, etc.) during transport along those routes; and the plethora of restrictions, codes, requirements, etc. for the different jurisdictions along those routes.

Due to these complex factors, the analysis, predictions, and recommendations performed by the disclosed system 100 and process 200 cannot be practically performed in the human mind using conventional resources. The required information is too dispersed among disparate sources and is too extensive to be practically handled using conventional resources and current techniques. In fact, the conventional resources and current techniques have multiple manual steps, require frequent trial and error, and provide limited geographical coverage so only a patchwork solution can be achieved.

With this in mind, the subject matter of the present disclosure improves transportation logistics, freight brokerage, infrastructure planning, and regulatory compliance systems by enabling operators to move oversized cargo across multiple jurisdictions using different transport modes, eliminating the multiple manual steps, the frequent trial and error, and the limited geographical coverage found in current patchwork solutions.

### D. Clearance Process

Having an overview of the computing environment 50 and the comparative process 200, discussion now turns to FIG. 2B, which illustrates a clearance process 250 of determining a transportation route (e.g., railway route) and obtaining a clearance report to transport a load (e.g., transformer, boiler, pressure vessel, power generator, or other large equipment). For better understanding, reference is concurrently made to features of the computer environment 50 in FIG. 1 as well as to features in other figures disclosed herein.

In the discussion of the clearance process 250, focus is made on the railway transport mode in which a railway transport (e.g., a railcar or the like) is used to transport the oversized cargo load. As will be appreciated, similar techniques can be applied to the roadway transport mode, even though they may not be explicitly laid out.

In the clearance process 250, the computer system 100 obtains input data (Block 252). For example, the input data at least includes (i) mapping data for railways, (ii) historical clearance data for the railways, and (iii) schematic data at least associated with a load to be transported. The input data can also include (iv) an origin and a destination for transport of a load carried on a railcar.

To obtain the input data, the processor 106 can access the mapping data 130 and the historical clearance data 140 from storage in the database 102 or from a remote system 118, such as a cloud storage or an enterprise system. As noted previously, the mapping data 130 can include rail network information in one or more geographical locations. As also noted, the historical clearance data 140 can include clearance measurements made along the various rail network routes in one or more geographical locations. For example, various clearance measurements may be periodically made and updated along railroad routes. For instance, laser measuring devices (e.g., LiDAR distance laser) mounted on a vehicle riding along the track can be used to make the measurements. Railways also often make measurements of track centers and curves and maintain that data.

As discussed in more detail below, the input data may already include a railcar to be used to transport the load. For example, this may be contained in schematic data input into the computer system 100. In other instances, schematic data of only the load is input into the computer system 100. Accordingly, the computer system 100 can provide for the selection of a railcar to be used to transport the subject load (Block 254). The selection can be a user-based selection received by a user in a graphical user interface.

For rail clearance, for example, the disclosed system 100 can determine and recommend a system-initiated railcar type. In certain configurations, the disclosed system 100 is configured to autonomously determine one or more candidate railcar types suitable for a given load configuration based on physical dimensions, center of gravity, axle load distribution, clearance envelope constraints, and route-specific infrastructure parameters. Rather than requiring the user to pre-select a railcar type, the disclosed system 100 can instead analyze the load attributes and available railcar classes and can generate a ranked set of feasible railcar arrangements. The ranking may be based on clearance probability, operational feasibility, cost efficiency, or regulatory compatibility. In some configurations, the disclosed system 100 presents the recommended railcar types to the user through a user interface, including a prompt, a pop-up window, or a conversational dialog. In the user interface, the user can accept, modify, or override the recommendation prior to execution of a clearance analysis in the disclosed system 100.

For example, the computer system 100 in the rail movement feasibility analysis receives load configuration data including dimensional geometry, weight distribution, and overhang characteristics. The computer system 100 queries a railcar classification dataset comprising multiple railcar types and automatically determines a subset of railcar types compatible with the load configuration. The computer system 100 then ranks the subset based on predicted clearance feasibility along a proposed route, and at least one recommended railcar type is presented by the computer system 100 to a user for selection in a user interface prior to clearance simulation. This railcar selection can be helpful because the user does not need to “already know” the correct railcar type.

The computer system 100 now extracts dimensional data (Block 256). If the input data includes image data, for example, the image processing module 112 processes the schematic data of at least the load. Based on the processed data, the computer system 100 determines dimensional parameters associated with the load carried on the railcar. In turn, based on the dimensional parameters, the image processing module 112 defines a transport envelope of the load carried on the railcar.

With this set up of processed input data, parameters, and transport envelope, the mapping module 114 operates a machine learning algorithm to determine the railway networks connecting between the origin and the destination (Block 258). The rail system in North America is comprehensive and interconnected, and States have few restrictions for moving large loads by rail. As expected, one or more railroad routes over one or more portions of railway networks may be accessible to transport from the origin (O) to the destination (D). The mapping module 114 identifies any of the one or more relevant railroad routes that are accessible.

For example, the mapping module 114 can determine the railway networks connected between the origin and the destination by: discovering any one or more sections of any one or more of the railway networks being interconnected to one another between the origin and the destination; and outlining any one or more routes along the any one or more sections connecting the origin to the destination.

At this stage of the clearance process 250, the predictive modeling module 108 obtains the historical clearance data 140 for the determined route(s) (Block 260). Some of the relevant historical clearance data 140 may be stored in the database 102, and some may be accessed from a remote system 118.

Using the one or more determined route(s), the dimensional parameters, and the historical clearance data, the AI model 110 of the predictive modeling module 108 performs predictive modeling (Block 262) and determines predictive results (e.g., probabilities, confidence intervals, pass-fail scores, tabulated numbers of critical points, etc.) for clearance of the load carried by the railcar along the determined route(s) (Block 264). The predictive results can in general include one or more metrics characterizing the transport envelope of the load carried on the railcar clearing the historical clearance data on the one or more railway routes.

As its goal, the predictive modeling module 108 seeks to calculate a probability value, a confidence interval, a pass-fail score, a tabulated number of critical points, or other numerical metric of securing suitable clearance along the one or more identified routes. For example, using the AI model 110, the predictive modeling module 108 determines probabilities or other metrics characterizing the transport envelope of the load carried on the railcar clearing obstacles in the historical clearance data on the determined route(s) of the railway network(s). The calculations can use dynamic adjustment factors, safety margins, and accuracy metrics. The analysis for the clearance may also use calculations for any speed restrictions in passing critical points along the railway route. Because the required processing may be intensive, the computer system 100 can use dedicated and/or remote resources to perform the analysis, such as provided by a remote system 118.

For rail clearance, the predictive modeling module 108 can use parameters for the track geometry, curvature, and the like to perform more dynamic envelope modeling. In certain configurations, for example, the disclosed system 100 incorporates track geometry parameters, including but not limited to curvature radius, superelevation, transition spirals, and articulation behavior, into the clearance analysis. The predictive modeling module 108 then models dynamic load movement through curved track segments by simulating lateral displacement, rotational sweep, and overhang amplification occurring as the railcar traverses curves of varying radii. This modeling is particularly relevant for low-profile railcars and loads with extended lower geometries, where bottom-side clearance constraints differ from straight-track conditions. When necessary for these types of rail cars, the predictive modeling module 108 may evaluate all curve geometries along a route and determine whether any individual curve segment presents a clearance conflict, regardless of whether straight-track clearance is sufficient.

For this dynamic analysis, the predictive modeling module 108 models dynamic movement of the load and railcar through curved track segments and computes clearance envelopes as a function of curvature radius and railcar articulation. The predictive modeling module 108 then identifies any clearance conflicts arising exclusively from curved-track geometry. Depending on jurisdictions, the predictive modeling module 108 can be configured to apply track geometry analysis based on regional rail standards, including variations in curve radius tolerances, infrastructure design, and regulatory requirements.

Using the AI model 110, the predictive modeling module 108 generates a clearance prediction (Block 266), which is assessed (Decision 268). If the clearance is appropriate (Yes), the predictive modeling module 108 determines, based on the determined probabilities or other metric(s), at least one route on one or more of the determined routes connecting the origin to the destination and generates a clearance report or recommendation (Block 276). The clearance report can include information indicative of the at least one route to transport the load carried on the railcar. This clearance report can be communicated with one or the input-output interfaces, such as a computer screen, a printer, an electronic communication, or the like.

In some instances, the clearance process 250 may produce clearance probabilities or metrics that are not adequate when the clearance process 250 determines whether clearance has been achieved within an appropriate threshold of probability or the like (Decision 268). In general, the AI model 110 can determine that the one or more metrics for the railway routes fail to meet a criterion for the transport envelope of the load carried on the railcar to clear the historical clearance data on the railway routes. For example, the AI model 110 may instead determine that the probabilities fall below a threshold. Should clearance issues arise, the computer system 100 can mark the schematic data, such as the image file, what the “clearance window” would be (Block 270). In this case, the AI model 110 can define at least a maximum clearance window along at least one of the routes having the one or more metrics closest to meeting the criterion, e.g., having at least a higher level of the probabilities. Then, the AI model 110 can suggest one or more alternatives to at least the railcar to match the maximum clearance window (Block 272) and can revise the proposal (Block 274) so the analysis can be repeated. Other alternatives can also be recommended. For example, an alternative railway route may be determined and suggested to the user.

At Block 272, the computer system 100 can also automatically select a railcar type based on characteristics of the load and the identified routes. For example, given the load's dimensional parameters, the historical clearance data, and the one or more identified routes, the computer system 100 may determine an appropriate type of railcar for the load if a specialized form of transport is necessary. For example, the computer system 100 may determine a specialized type of railcar to achieve the transport. To do this, the computer system can reference a database of specialized railcars, either stored in the database or obtained from an external system (e.g., from Kasgro Rail Corporation).

To obtain the input data in Block 252, the schematic data can be manually input by a user in a user interface by filling out form fields for different dimensions of interest. Although this represents one possibility, allowing schematic image data to be used greatly simplifies and streamlines the clearance process. Accordingly, to obtain the input data in Block 252, the schematic data can be schematic image data obtained using an image capture interface, such as a camera, a scanner, or other imaging devices. Alternatively, the schematic data may be an image file stored in the database 102 of the computer system 100, and the processor 106 can access the image file from storage. The image file can be received from a remote system (118) and can be downloaded to the database 102 for later retrieval. Likewise, the image file can be generated with the computer system 100 using appropriate software and stored in the database 102 for later access.

In fact, AI models at remote systems 118 can be accessed through application program interfaces (API) to generate AutoCAD drawings for the image files, including generating code snippets in various programming languages to automate and enhance AutoCAD design processes. Additionally, open-source applications can generate CAD files from text prompts, allowing models to be created and imported into CAD programs.

### E. Example Image Files

As examples, FIGS. 3A and 3B illustrate representations of image files 300A-B for use by the disclosed computer system 100. These image files 300A-B can include any combination of depictions of the load with dimensional information, depictions of a railroad car with dimensional information, and tables and/or other textual information. For example, the image files 300A-B in FIGS. 3A-3B include an end view 302 of the load (e.g., transformer) with dimensional information when supported on a selected railroad car. The image files 300A-B also include a side elevational view 304 of the load (e.g., transformer) with dimensional information when supported on the selected railroad car. A table 306 is depicted and includes clearance dimensions in the form of widths of the load on the railroad car at different heights from the rail. Additional textual information 308 may also be provided as shown in the image file 300B. The AI model 110 can use transforms 111 and language models to extract text from any tables 306 and textual information 308 in the image files.

In the clearance process 250 of FIG. 2B, dimensional parameters for the load and the railcar can be extracted from these types of image files by the image processing module 112. As an example, manufacturer drawings of the load to be transported can be uploaded to the computer system 100. The load can be equipment, such as a transformer, a boiler, a wind turbine component, or any type of heavy-lift and over-dimension cargo, which requires significant coordination and time to transport. The drawings may also include a selected railcar on which the load is to be transported.

The image file for these drawings can be in a suitable format, such as PDF, AutoCAD, or other formats. The computer system 100 processes the image file to determine dimensional parameters related to the load and the railcar (if present in the image file). These dimensional parameters can include one or more values for the load's vertical dimension (e.g., height), lateral dimension (e.g., width, diameter, etc.), and the longitudinal dimension (e.g., length).

Moreover, more than one image file can be uploaded to, retrieved from, or generated by the computer system 100 to be processed and combined, such as one image file for the load and another image file for the railcar. If the image files uploaded to the computer system do not include the railcar, for example, then one or more separate image files for the desired railcar may be uploaded to the computer system. Alternatively, a particular railcar can be separately selected in the computer system 100, and the dimensions for the railcar combined with the dimensional parameters of the load extracted from the image file. For example, user selections can be made in a user interface of the computer system to select a desired railcar. Typical rail cars include a flat car, a bulkhead flat car, a gondola car, a hopper car, and the like.

To determine the dimensional parameters associated with the load carried on the railcar, first dimensional parameters associated with the load can be determined by processing the schematic image data of the load without image data of a railcar to be used. Instead, a user-based selection of the railcar can be obtained using a graphical user interface, and the selection can be obtained from storage in the database. Alternatively, the computer system 100 may make the selection of the railcar automatically based on the first dimensional parameters associated with the load as well as any other details related to the load (e.g., name of the load, type of the load, etc.). Second dimensional parameters associated with the selection of the railcar are then added to the first dimensional parameters associated with the load to complete the combined dimensional parameters.

Selecting the railcar for the given load and route(s) by the computer system 100 may take into account one or more parameters, including weight of the load relative to the railcar's capacity, length of the load relative to the platform size of the railcar, height of the load compared to the platform height, number of axles for calculating and approving weight distribution per axle on the railcar, location of the center of gravity (COG) of the load, and availability and cost of the railcar. Not all railcars may be available for every route and departure location. If a specific car is found to be unavailable, the process can adjust the selection accordingly. Railcar data can be accessed directly from remote systems (118) to obtain technical specifications, technical diagrams, and official data from railcar manufacturers.

As an alternative, the schematic image data being processed may have both the load and the railcar included. In this case, the combined dimensional parameters associated with the load carried on the railcar can be completed based on processing the image data.

### F. Clearance Envelopes

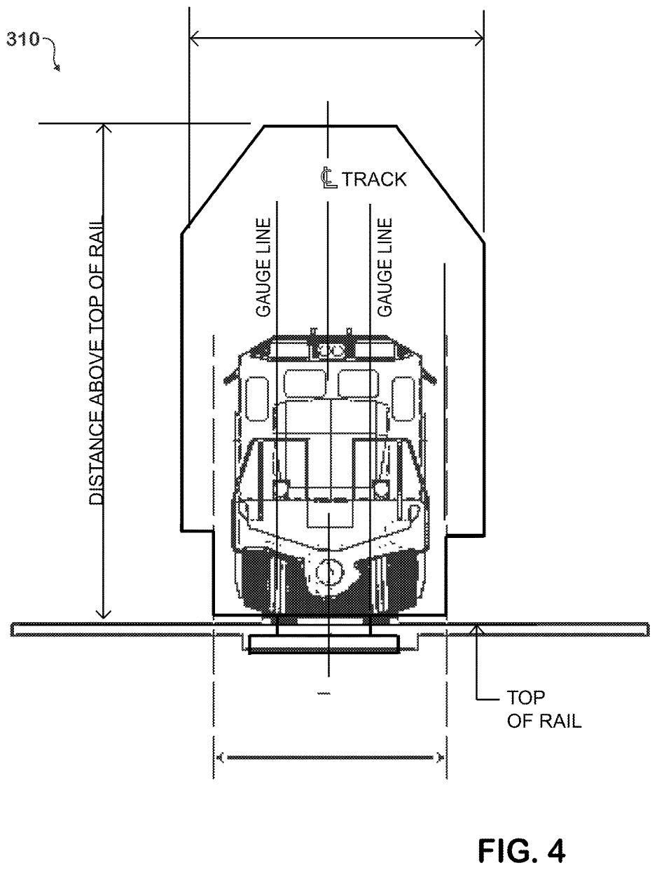

To define the transport envelope of the load carried on the railcar, the computer system 100 appropriately scales and combines the dimensional parameters. For better understanding of the transport envelope, FIG. 4 illustrates an example of a maximum clearance profile 310 for a train on a railway. As noted above, dimensional parameters can include one or more values for the load's vertical dimension (e.g., height), lateral dimension (e.g., width, diameter, etc.), and the longitudinal dimension (e.g., length). Additionally, the dimensional parameters of the computer system 100 can include one or more values of the railcar's vertical dimension (e.g., height), lateral dimension (e.g., width, diameter, etc.), and longitudinal dimension (e.g., length). Moreover, given that the load is to be carried on the railcar and may be held on various support structures, the dimensional parameters can include one or more values for the combined vertical dimension (e.g., combined height above the rail), lateral dimension (e.g., width, diameter, etc.), and the longitudinal dimension (e.g., length). Additional parameters, such as weight, horizontal center of gravity relative to the geometric center, combined vertical center of gravity above the rail, etc., related to the load and/or transport may be extracted from the image file or received through user inputs.

The clearance in the maximum clearance profile 310 is defined as a distance from an outer edge of the load to structures on the railroad right-of-way. Many railroads have different minimum clearance distances to be met. The clearance required can also be related to the speed of the railcar passing the structure. For example, a smaller clearance distance would relate to a slower speed, whereas a greater clearance distance would relate to a higher speed. Some obstacles may require the train to pass at walking speed to pass the obstacle. A predefined clearance distance may be needed for the railcar to travel at track speed past the structure. Because trains on adjacent rails may pass by the load, clearance requirements also account for the track centers (i.e., the distance from the centerline of one track to the centerline of adjacent track(s)).

In general, a “loading gauge” can refer to a maximum physical size of a railcar and its load. By measuring various dimensions along the length of the railcar and carried load, the processor can determine the loading gauge for the specific configuration. Although the loading gauge describes the outer dimensions of configuration of the railcar and its load, the railcar with the load can occupy a more dynamic envelope representing a larger volume that rolling stock can occupy as it travels along a railway track at speed.

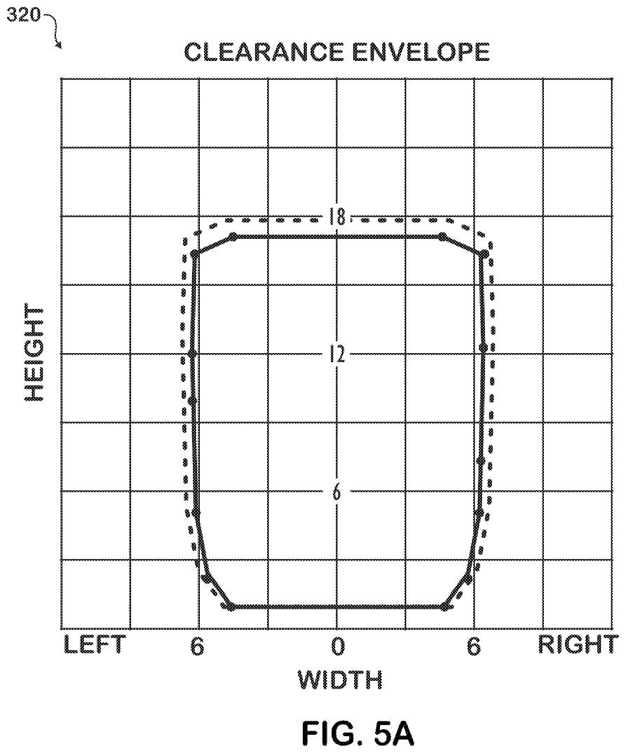

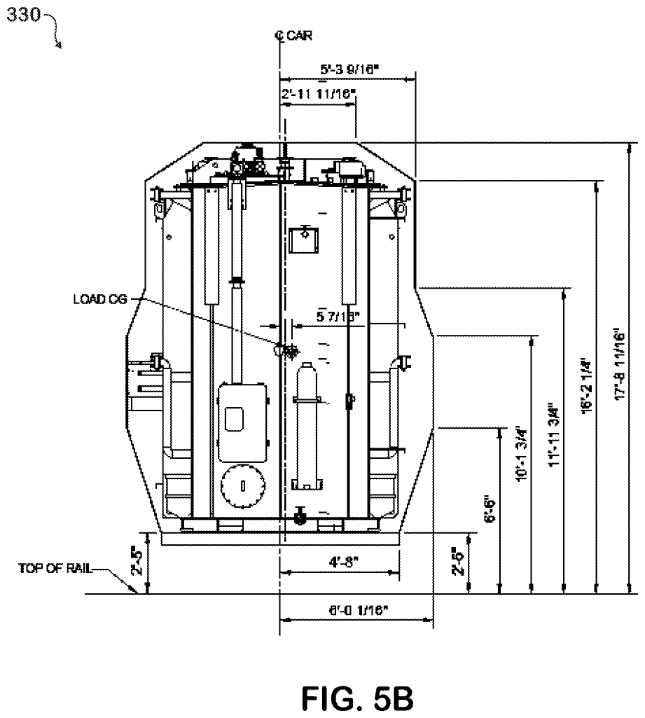

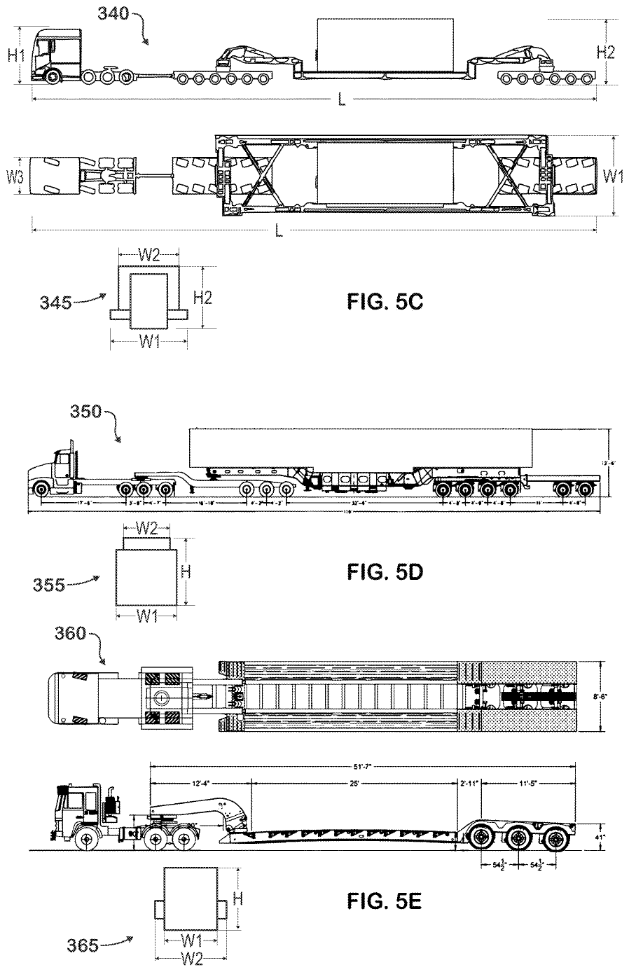

For example, FIG. 5A illustrates an example of a calculated clearance envelope 320 for a railcar and a load. The envelope is generally defined by the combination of height, width, and the edge chamfers from both the top and bottom corners of the load profile (front view) on the railcar relative to the top of the rail and the centerline. Lateral swaying, vertical bouncing, track canting around corners, and the like can produce the larger dynamic clearance envelope, which is also shown in FIG. 5A.

For further explanation, FIG. 5B illustrates a more detailed example of a calculated clearance envelope 330 for a railcar and a load. In this example, the load is a transformer. The railcar (not shown) in this example is 9′ 4″ wide and 2′ 5″ high. Multiple coordinates (i.e., widths relative to the railcar's centerline at specific heights from the top of rail) for the geometric data are detailed for the load, and the profile for the calculated clearance envelope 330 is defined by these coordinates. The load's center of gravity is also given.

As noted previously, the predictive modeling module in FIG. 2B calculates a distance between obstacles (structures, etc.) and the clearance envelope of the railcar and the load. The calculation may account for the speeds at which the envelope can pass. Additionally, the calculation can account for appropriate track tolerances and the accuracy of measurements. The clearance envelope developed by the computer system 100 may be displayed in a graphical user interface, and the user may be able to make adjustments and refinements in the interface.

In the predictive analysis, the clearance envelope of the load on the railcar is checked for fit and clearance issues along the route(s). Clearance data along the route is accessed from a clearance database to perform the comparative fit. Weight restrictions (e.g., weight restriction data) along the route are also checked in the comparison. Therefore, the criteria for the clearance prediction may account for the overall size and gross weight of the load, the maximum allowable dimensions (“envelope”), and the combined weight and size of load and railcar for the route.

For height and width of the load on the railcar, the calculations add together the load's and railcar's height and width, and the calculations check that the combined heights and widths constructing the transport envelope do not exceed the clearance limitations defined in the maximum allowable dimensions (“envelope”) for a given route. To calculate the weight per axle, the weight of the load is combined with the weight of the empty car, and the total weight is divided by the number of axles on the car. The aim is to keep the center of gravity (COG) of the load as close as possible to the center of the railcar, using counterweights if necessary. Additionally, the COG of the load is preferably as close as possible to the longitudinal center of the railcar to avoid creating an imbalance in the weight distribution that exceeds certain thresholds, such as 10% on either axle group (front or rear).

Similar to how the schematic input, dimensional information, profiles, and clearance envelopes described above are analyzed with respect to railcars to transport oversized loads as noted above, trucking arrangements can also be analyzed based on comparable information. For heavy, oversized hauling of superloads, the trucking arrangement can use various components, such as tractors, jeeps, dollys, stingers, trailers, boosters, etc.

For example, FIG. 5C illustrates an example of schematic input 340 and a calculated clearance envelope 345 for a superload trucking arrangement for a load. Here, the superload trucking arrangement includes sixteen axles, including a specialized tractor truck to haul dual transport modules with an intermediate support for the load. FIG. 5D illustrates another example of schematic input 340 and a calculated clearance envelope 345 for a trucking arrangement for a load. Here, the trucking arrangement has thirteen axles and includes a tractor truck, a drop deck trailer, and a stinger. FIG. 5E illustrates schematic input 340 and a calculated clearance envelope 345 for a trucking arrangement. Here, the trucking arrangement includes a three-axle tractor truck connected to a double dop lowboy trailer with three axles. As will be appreciated, these are just brief examples of the multiple types of trucking arrangements that may be available for use in transporting oversize cargo loads.

### G. Graphical User Interface

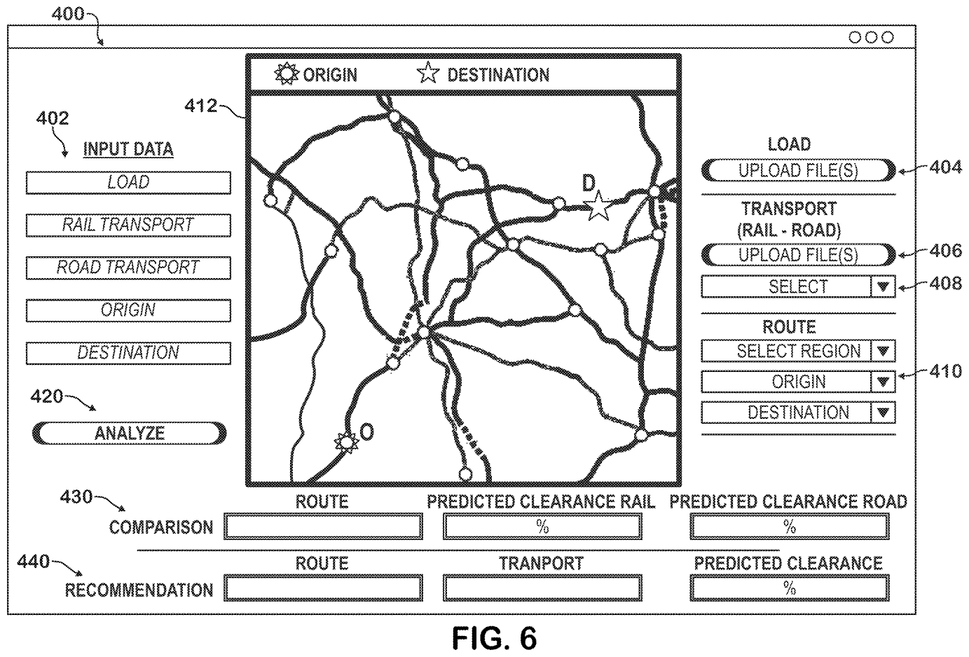

As noted above, the computer system 100 can receive user inputs for the transportation of the load. To obtain the input data, for example, the computer system 100 can obtain the origin and the destination using a graphical user interface. For example, FIG. 6 illustrates an example graphical user interface 400 for configuring, selecting, and entering information. As will be appreciated, any number of formats can be used for the graphical user interface 400 of the computer system (100), and the graphical user interface 400 can use any number of screens, windows, and the like to display information and receive user input.

Input data 402 for analysis can be displayed and can include information about the given load, the rail transport, the road transport, the origin for starting the transport, and the destination for ending the transport. Various inputs may be provided for users to enter the information for the input data 402 to be analyzed. In this example, an upload 404 of a schematic image file can be selected for the load, and an upload 406 of a schematic image file can be selected for the transport (e.g., railcar and trailer). A drop-down selection 408 of available transports (railcars or trailers) can also be provided to receive user input. Route information 410 can be entered by selecting a geographical region, an origin, and a destination for the transportation of the load. Within the graphical user interface 400, the route information may be selectable as stored locations in the computer system (100), may be selectable locations on a visual map 412, or may use form fields for entering physical addresses, locations, or other geographical information.

Once schematic image file(s) and other input data 402 are entered, an analysis 420 can be initiated in the graphical user interface 400 to determine the clearance envelope of the load and transports and can provide results 430, 440 for the given inputs. As disclosed herein, the analysis can provide comparative results 430. For example, the comparative result 430 can provide predictive clearance values, e.g., estimates of how the given load on the selected transports (railcar, trailer, etc.) can clear the various clearance limits that are known on one or more selected routes. The information in the comparative results 430 can be calculated as a percentage, a confidence level, or another numerical value. The analysis can also generate a recommendation result 440 based on the comparative analysis of the input data 402. The recommendation result 440 can generate the recommended transport, route, and other information. The results 430, 440 can be arranged in a hierarchy or other type of comparison. The results 430, 440 can be output in another graphical user interface, in tables, and in any other suitable format.

Should the predicted clearance fall below a predefined threshold or other metric, the computer system (100) can highlight any issues in the results 430, 440, such as pinpointing any critical points where clearance is restricted or obstructed. The computer system (100) can also determine and provide a suggested alteration within the results 430, 440. For example, the computer system (100) can provide one or more alternative transports (e.g., railroad cars, trailers, etc.) for transporting the load. Also, the computer system (100) can provide one or more alternative routes for transporting the load.

Because the disclosed system 100 generates predictions and makes recommendations, the disclosed system 100 can include a conversational or chatbot interface to assist the user with the rail clearance decisioning making. In certain embodiments, the disclosed system includes a conversational interface configured to interact with a user through natural language inputs and outputs. The conversational interface may receive user inquiries relating to railcar selection, route feasibility, clearance risks, or alternative transport modes and respond with system generated recommendations derived from the underlying clearance models and datasets. In turn, the conversational interface may guide the user through a sequence of decision steps, including clarifying load attributes, proposing alternative railcar configurations, highlighting clearance risks, or recommending alternative routes or transport modes.

For this decision-making function, the processing device can include a rail clearance analysis engine; a natural language processing module; and a conversational interface. The conversational interface is configured to receive user queries related to rail movement feasibility. The conversational interface then invokes the clearance analysis engine and returns clearance recommendations or explanations in natural language form.

### H. Convolutional Neural Network

As noted above, the disclosed systems and methods use AI techniques, such as a convolutional neural network (CNN) for image-based evaluations. The CNN is trained directly with graphical representations to evaluate and classify the quality of the threaded tubular connections.

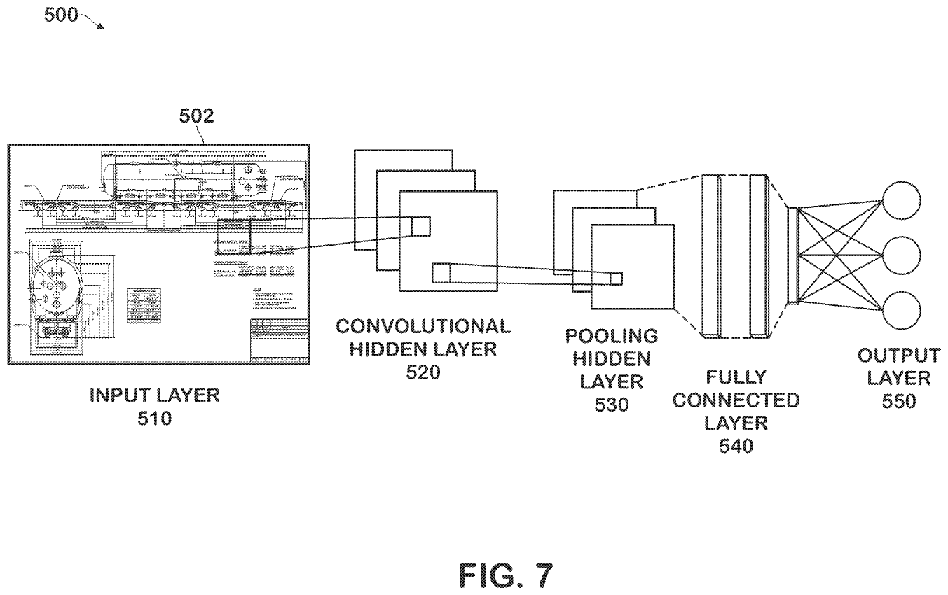

FIG. 7 schematically illustrates a convolutional neural network (CNN) 500 used for automated evaluation and analysis of graphical representations in a computing environment. (Reference numerals to elements in other figures are provided in the discussion below.)

Again, the computer environment (50) can include the computer system (100), remote system (118), and processes (200, 250) discussed above. The CNN 500 is a type of deep neural network (DNN) having three additional features: local receptive fields, shared weights, and pooling. An input layer 510 and an output layer 550 of the CNN 500 function similar to the input and output layers of a DNN. However, the CNN 500 is distinguished from a DNN in that hidden layers of the DNN are replaced with one or more convolutional hidden layers 520, pooling hidden layers 530, and fully connected hidden layers 540.

Using localized receptive fields, nodes in the convolutional hidden layers 520 receive inputs from localized regions in the previous layer. Meanwhile, using shared weights, each node in a convolutional hidden layer 520 assigns the same set of weights to the relative positions of a localized region.

The input layer 510 of the CNN 500 includes data representing an image 502 (e.g., a graphical representation, graphical user interface, graphs, curves, tables, etc. uploaded to the image processing module 112). For example, the data can include an array of numbers representing the pixels of the image, with each number in the array including a value from 0 to 255 describing the pixel intensity at that position in the array. The image can be passed through a convolutional hidden layer 520, an optional non-linear activation layer (not shown), a pooling hidden layer 530, and fully connected hidden layers 540 to get an output at the output layer 550. While only one of each hidden layer is shown in the present example, it is appreciated that multiple convolutional hidden layers 520, non-linear layers, pooling hidden layers 530, and/or fully connected hidden layers 540 can be included in the CNN 500.

The first layer of the CNN 500 is the convolutional hidden layer 520, which analyzes the image data of the input layer 510. Each node of the convolutional hidden layer 520 is connected to a region of nodes (pixels) of the input image called a receptive field. The convolutional hidden layer 520 can be considered as one or more filters (each filter corresponding to a different activation or feature map), and each convolutional iteration of a filter can be considered a node or neuron of the convolutional hidden layer 520. For example, the region of the input image that a filter covers at each convolutional iteration would be the receptive field for the filter. Each connection between a node and a receptive field for that node learns a weight and, in some cases, an overall bias such that each node learns to analyze its particular local receptive field in the input image. Each node of the convolutional hidden layer 520 will have the same weights and bias (called a shared weight and a shared bias). For example, the filter has an array of weights (numbers) and the same depth as the input.

The convolutional nature of the convolutional hidden layer 520 is due to each node of the convolutional layer being applied to its corresponding receptive field. At each convolutional iteration, the filter's values are multiplied by a corresponding number of the original pixel values of the image data. The multiplications from each convolutional iteration can be summed together to obtain a total sum for that iteration or node. The process is continued at a next location in the input image according to the receptive field of the next node in the convolutional hidden layer 520. For example, a filter can be moved by a step amount to the next receptive field. Processing the filter at each unique location of the input volume produces a number representing the filter results for that location, resulting in a total sum value being determined for each node of the convolutional hidden layer 520.

The mapping from the input layer 510 to the convolutional hidden layer 520 is referred to as an activation map (or feature map). The activation map includes a value for each node representing the filter results at each location of the input volume. The activation map can include an array containing the various total sum values resulting from each iteration of the filter on the input volume. The convolutional hidden layer 520 can include several activation maps to identify multiple features in an image.

Applied after the convolutional hidden layer 520, the pooling hidden layer 530 simplifies the information in the output from the convolutional hidden layer 520. The pooling hidden layer 530 takes each activation map output from the convolutional hidden layer 520 and generates a condensed activation map using a pooling function. Max-pooling is one example of a pooling function that can be performed by the pooling hidden layer 530. The pooling hidden layer 530 may also use other known forms of pooling functions. The pooling function is applied to each activation map in the convolutional hidden layer 520.

In the final layer of connections in the CNN 500, the fully connected hidden layer 540 connects every node from the pooling hidden layer 530 to every one of the output nodes in the output layer 550. The fully connected hidden layer 540 obtains the output of the previous pooling hidden layer 530 (which represents the activation maps of high-level features) and determines the features that best correlate to a particular class. For example, the fully connected hidden layer 540 can determine the high-level features that strongly correlate to a particular class and can include weights (nodes) for the high-level features. A product can be computed between the weights of the fully connected hidden layer 540 and the pooling hidden layer 530 to obtain probabilities for the different classes. For example, if the CNN 500 is being used to predict that an object is a torque-turns curve, high values will be present in the activation maps that represent high-level features of a torque-turns curve.

As noted previously, the modules (e.g., the predictive machine learning module 108, the image processing module 112, and the mapping module 114) can be implemented using appropriate forms of artificial intelligence, such as a deep neural network or other AI models. In the ML pipeline, the AI models of the present disclosure can be trained by a software framework of a machine learning engine that manages, trains, deploys, and serves the AI model 110 according to the present disclosure. Existing engines, such as TensorFlow Serving or AWS SageMaker, can provide the infrastructure to deploy the AI model 110 of the present disclosure.

### I. Training System

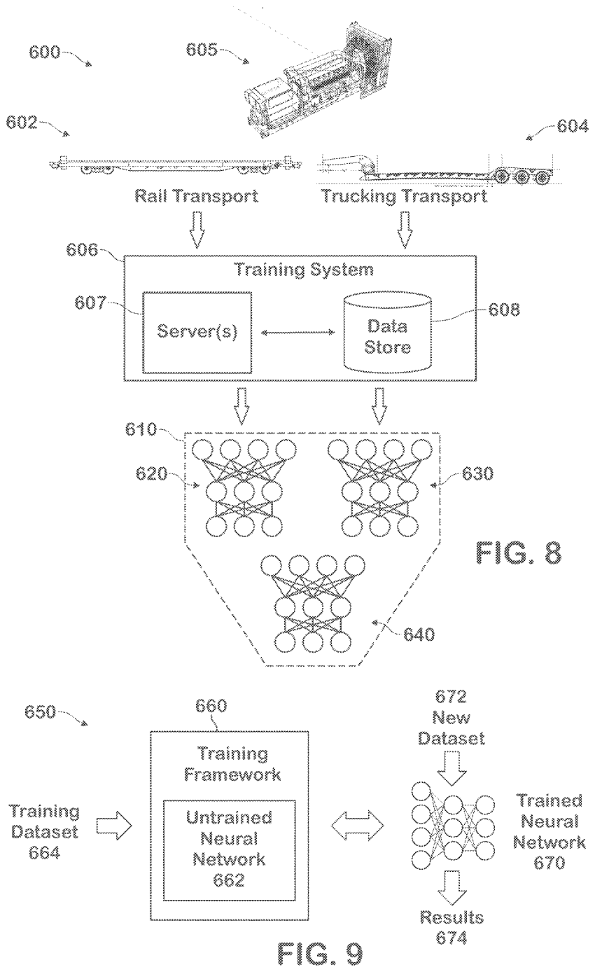

FIG. 8 schematically illustrates a training system for training a model 610 according to the present disclosure in an artificial intelligence computing environment 600. The model 610 can include one or more functional models for the purposes disclosed herein, such as a dimensional-analysis model 620, a predictive model 630, and a comparative model 640. These can be separate models from one other, or they can be integrated as a unitary model. The training system 606 can include one or more servers 607 (e.g., a processing unit server) and data stores 608 and may use a cloud-based deep learning infrastructure with artificial intelligence to analyze the input data associated with load data 605, railway transport data 602, and roadway transport data 604. The data can be stored in the data stores 608 and/or can be accessed remotely. The training system 606 can also incorporate or train up-to-date, real-time neural networks (and/or other machine learning models) for the one or more models.

The training system 606 teaches the dimensional-analysis model 620 to determine the dimensions of loads and transports based on schematic information, image input, and the like. The training system 606 teaches the predictive model 620 to predict clearance of the loads transported by the transports along the routes of the transport modes in light of all of the requirements, limitations, and other constraints associated with those transport modes. The training system 606 teaches the comparative model 640 to compare the predictions for the clearance of the transports transporting the loads on the routes for the transport modes and to generate a recommendation. Once trained, the models 620, 630, 640 can then be used in the systems and processes disclosed herein.

In one configuration, the models 620, 630, 640 can be trained using real-world data obtained. Also, training data for the models 620, 630, 640 can be generated based on simulated or modelled environments to produce synthetic data. For example, the training data may include synthetic data artificially created by simulations in modeling software, and the training data may then be used to train the models 620, 630, 640 for use in a real-world application to help operators plan and execute transport of an oversized cargo load. In some implementations, the training data may be updated with real-world data such that the training datasets include both synthetic data and real-world data.

In general, the elements described herein may be implemented as discrete or distributed components in any suitable combination and location. The various functions described herein may be conducted by hardware, firmware, and/or software. For example, a processor may perform various functions by executing instructions stored in memory.

The model 620, 630, 640 can include a deep neural network (DNN) and can support generative learning. For example, the models 620, 630, 640 can include a generative adversarial network (GAN), a variational autoencoder (VAE), and/or another type of DNN or machine learning model. Generally, the models 620, 630, and 640 can accept input data in any suitable format.

The architecture of the models 620, 630, 640 can be selected to fit the shape of the desired input and output data. Example architectures (e.g., DNNs) include, but are not limited to, perception, feed-forward, radial basis, deep feed-forward, recurrent, long/short term memory, gated recurrent unit, autoencoder, variational autoencoder, convolutional, deconvolutional, and generative adversarial. Some DNN architectures, such as a GAN, can include a convolutional neural network (CNN) that accepts and evaluates an input image and may include multiple input channels, which may be used to accept and evaluate multiple input images and/or input vectors.

### J. Training Process

As an example, FIG. 9 illustrates a training process 650 for a training framework to train and deploy a trained neural network 670 in which configurations of the present technology may be implemented. The neural network 418 includes an input layer, a plurality of hidden layers, and an output layer. The neural network 418 can be a deep neural network (DNN), a deep auto-encoder neural network (deep ANN), a convolutional neural network (CNN), a recurrent neural network (RNN), or any other suitable neural network.

For the purposes of the present disclosure, the neural network 670 for the image processing module (112) can use a CNN as discussed herein to process schematic data for image file(s). The CNN is specifically designed for working with grid-like data, such as images, and can effectively perform tasks, such as image classification, object detection, image segmentation, and the like. The CNN uses convolutional layers to automatically detect patterns, such as edges, textures, and shapes, within the schematic image data to capture spatial hierarchies. Pooling layers within CNN reduce the spatial size of the representation, making the model less sensitive to small shifts or distortions in the image.

For the purposes of the present disclosure, the predictive modeling module (108) can use a DNN because the input data may be complex and unstructured. The DNN can handle the complex data structures to learn intricate patterns. The deep learning models, including CNNs, RNNs, and transformers, can be employed. For example, two or three-dimensional models of the railcar/load and obstacle clearances can train CNNs to predict whether the railcar can pass through specific obstacles on the railways. The model can analyze the shape and clearance of obstacles and compares them with the load/railcar's dimensions.

For the purposes of the present disclosure, the mapping module (114) can use any number of algorithms to determine routes, pathways, and logistics between the original and destination along the railways. For example, the mapping module (114) can use a Graph Neural Network (GNN) for graph-based route planning. Other algorithms include Genetic Algorithm (GA), Ant Colony Optimization (ACO), Mixed Integer Linear Programming (MILP), and Heuristic Search Algorithm.

In the end, each function of the AI models (110, 113, 115) in the various modules (108, 112, 114) could be combined together in a neural network.

As illustrated, the neural network 418 may have any number of two or more hidden layers. Each layer may have one or more nodes (represented by circles in the diagrammatic network). As depicted by the connecting lines, each node in a current layer is connected to every other node in a previous layer and a next layer. This is referred to as a fully connected neural network. Other neural network structures are also possible in alternative arrangements of the neural network 418, in which not every node in each layer is connected to every node in the previous and next layers.

Each node in the input layer can be assigned a value and output that value to every node in the next layer (e.g., hidden layer). The nodes in the input layer can represent features about a particular image. For example, a DNN used for classifying whether an object is a rectangle may have an input node representing whether the object has flat edges. In this example, assigning a value of 1 to the node may represent that the object does have flat edges and assigning a value of 0 to the node may represent that the object does not have flat edges. In another example, for the DNN taking an image as input, the input nodes may each represent a pixel of the image, such as a pixel of a training image, where the assigned value may represent the intensity of the pixel. Following this example, an assigned value of 1 may indicate that the pixel is completely black and an assigned value of 0 may indicate that the pixel is completely white.

Each node in the hidden layers can receive an output value from nodes in a previous layer (e.g., input layer) and associate each of the nodes in the previous layer with a weight. Each hidden node can then multiply each of the received values from the nodes in the previous layer with the weight associated with the nodes in the previous layer and output the sum of the products to each node in the next layer.

Nodes in the output layer handle input values received from the nodes in the hidden layer in a similar fashion. In one example, each output node in the output layer may multiply each input value received from each node in the previous layer (e.g., hidden layer) with a weight and sum the products to generate an output value. The output value of each output node can output information in a predefined format, where the information has some relationship to the corresponding information from the previous layer. Example outputs may include, but are not limited to, classifications, relationships, measurements, instructions, and recommendations. For example, a DNN that classifies whether the object is an ellipse, where an output value of 1 from the output node represents that the object is an ellipse and an output value of 0 represents that the object is not an ellipse. While the examples provided relate to classifying geometric shapes, this is only for illustrative purposes. The output nodes can also be used to classify any of a wide variety of objects and other features and otherwise output any of a wide variety of desired information in desired formats.

As further shown, FIG. 9 also illustrates the training process 650 for a training framework 660 to train and deploy a trained neural network 670 according to the present disclosure. Again, in the ML pipeline, the AI models of the present disclosure can be trained by a software framework of a machine learning engine that manages, trains, deploys, and serves the AI model according to the present disclosure. Once a given untrained neural network 662 has been structured for a task, the untrained neural network 662 is trained using a training dataset 664 in the training framework 660.

To begin training, initial weights may be chosen randomly, by pre-training using a deep belief network, or by using pre-trained models. The training cycle can then be performed in either a supervised or unsupervised manner.

Supervised learning uses the training dataset 664 to teach the neural network 662 to yield the desired output. The training dataset 664 includes inputs and desired outputs, which allow the neural network 662 to learn over time, or when the training dataset 664 includes input having known output and the output of the neural network 662 is manually graded. The neural network 662 processes the inputs and compares the resulting outputs against a set of expected or desired outputs. Errors are then propagated back through the training framework 660.

As training proceeds, the training framework 660 can adjust and change the weights that control the untrained neural network 662. The training framework 660 can provide tools to monitor how well the untrained neural network 416 is converging towards a model suitable for generating correct answers based on known input data. The training process repeatedly occurs as the network weights are adjusted to refine the output generated by the neural network 662. The training process 600 can continue until the untrained neural network 662 reaches a statistical accuracy associated with a trained neural network 670. Given a new data set 672, the trained neural network 670 can then be deployed in the disclosed computer system (100) to implement any number of machine learning operations to output a result 674.

Supervised learning is typically separated into two types of problems-classification and regression. Classification uses an algorithm to assign test data accurately into specific categories. Regression is used to understand the relationship between dependent and independent variables. Numerous different algorithms and computation techniques can be used in supervised machine learning, including but not limited to, neural networks, naïve bayes, linear regression, logistic regression, support vector machines (SVM), k-nearest neighbor, and random forest.

As previously noted, unsupervised learning is a learning method in which the network uses algorithms to analyze and cluster unlabeled data. These algorithms discover hidden patterns or data groupings. Therefore, the training dataset 664 includes input data without any associated output data. The untrained neural network 416 can learn groupings within the unlabeled input and can determine how individual inputs relate to the overall dataset.

Unsupervised training can be used for three main tasks-clustering, association, and dimensionality. Clustering is a data mining technique that groups unlabeled data based on similarities and differences. This technique is often used to process raw, unclassified data objects into groups represented by structures or patterns in the information. Association is a rule-based method for finding relationships between variables in a given dataset. Dimensionality reduction is used when a given dataset's number of features (dimensions) is too high. This technique is commonly used in the preprocessing of data.

Variations of supervised and unsupervised training may also be employed. Semi-supervised learning is a technique in which the training dataset 664 includes a mix of labeled and unlabeled data of the same distribution. Incremental learning is a variant of supervised learning in which input data is continuously used to train the model further. Incremental learning enables the trained neural network 670 to adapt to the new data set 672 without forgetting the knowledge instilled within the network during initial training.

The techniques of the present disclosure can be implemented in digital electronic circuitry, or in computer hardware, firmware, software, or in combinations of these. Apparatus for practicing the disclosed techniques can be implemented in a computer program product tangibly embodied in a machine-readable storage device for execution by a programmable processor; and method steps of the disclosed techniques can be performed by a programmable processor executing a program of instructions to perform functions of the disclosed techniques by operating on input data and generating output. The disclosed techniques can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random-access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

The foregoing description of preferred and other embodiments is not intended to limit or restrict the scope or applicability of the inventive concepts conceived of by the Applicants. It will be appreciated with the benefit of the present disclosure that features described above in accordance with any configuration or aspect of the disclosed subject matter can be utilized, either alone or in combination, with any other described feature, in any other configuration or aspect of the disclosed subject matter.

In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

1. A computer-implemented method, comprising:
obtaining input data with one or more interfaces in a computing environment, the input data at least including (i) schematic information associated with a load to be transported, and (ii) requirement information associated with transport routes for each of a plurality of transport modes, a first of the transport modes being different from a second of the transport modes; and
operating one or more artificial intelligence models on one or more processors in the computing environment to:
determine dimensional parameters associated with the load based on the schematic information;
define, based on the dimensional parameters, a transport envelope of the load carried on a transport for each of the first and second transport modes;
determine, for each of the first and second transport modes, a metric characterizing the transport envelope in relation to the requirement information associated with the transport routes;
determine, based on the metrics, predictions for the transport envelope to clear the requirement information associated with the transport routes for each of the first and second transport modes;
perform dual-mode constraint analysis comparing the first transport mode versus the second transport mode based on the predictions to generate a comparative recommendation; and
output the comparative recommendation.

2. The method of claim 1, wherein to generate the comparative recommendation, the method comprises operating the one or more artificial intelligence models to weigh the first transport mode against the second transport mode in multi-criteria scoring.

3. The method of claim 1, wherein to obtain the schematic information, the method comprises operating the one or more artificial intelligence models to at least one of:
accessing the schematic information from memory in the computing environment with a memory interface of the one more interfaces;
obtaining the schematic information with an image capture interface of the one more interfaces; and
obtaining the schematic information with a network interface of the one more interfaces.

4. The method of claim 1, wherein to determine the dimensional parameters, the method comprises operating the one or more artificial intelligence models to:
determine load-related ones of the dimensional parameters associated with the load by processing the schematic information at least associated with the load;
add first of the dimensional parameters associated with the transport of the first transport mode to the load-related dimensional parameters; and
add second of the dimensional parameters associated with the transport of the second transport mode to the load-related dimensional parameters.

5. The method of claim 1, wherein the input data comprises transport information having stored transports for at least one of the transport modes; and wherein to determine the dimensional parameters and define the transport envelope in the at least one transport mode, the method comprises operating the one or more artificial intelligence models to:
receive a user-selected transport from one of the stored transports in the transport information; and
add transport-related dimensional parameters associated with the user-selected transport to load-related dimensional parameters associated with the load.

6. The method of claim 1, wherein to determine the dimensional parameters and define the transport envelope, the method comprises operating the one or more artificial intelligence models to:
process the schematic information having the load carried on the transport; and
determine the dimensional parameters from the processing.

7. The method of claim 1, wherein the schematic information comprises load-related schematic information associated with the load and comprises transport-related schematic information associated with stored transports for at least one of the transport modes; and wherein to determine the dimensional parameters and to define the transport envelope in the at least one transport mode, the method comprises operating the one or more artificial intelligence models to:
process the transport-related schematic information of the stored transports; and
add transport-related dimensional parameters associated with the stored transports to load-related dimensional parameters associated with the load.

8. The method of claim 1, wherein the input data comprises transport information having stored transports for at least one of the transport modes; and wherein to determine the dimensional parameters and define the transport envelope in the at least one transport mode, the method comprises operating the one or more artificial intelligence models to:
automatically select, in an automatic selection, a system-selected one of the stored transports to transport the load, the automatic selection being based at least on characteristics of the load, the system-selected transport, and the transport routes of the at least one transport mode; and
add transport-related dimensional parameters associated with the system-selected transport to load-related dimensional parameters associated with the load.

9. (canceled)

10. The method of claim 1, wherein to obtain the input data, the method comprises operating the one or more artificial intelligence models to:
obtain (iii) mapping information including an origin and a destination for transport of the load; and
determine, based on the mapping information, the transport routes connecting between the origin and the destination for each of the transport modes.

11. The method of claim 10, wherein to determine the transport routes connecting between the origin and the destination, the method comprises operating the one or more artificial intelligence models to:
discover any one or more sections of any of the transport routes being interconnected to one another between the origin and the destination; and
outlining the any one or more sections of the any of the transport routes connecting the origin to the destination.

12. The method of claim 1, wherein to determine a respective one of the metrics characterizing a respective one of the transport envelopes in a respective one of the transport modes, the method comprises operating the one or more artificial intelligence models to:
fit the respective transport envelope in a comparative fit to each of the transport routes associated with the requirement information of the respective transport mode; and
characterize the respective metric based on the comparative fits.

13. The method of claim 1, wherein to determine a respective one of the metrics characterizing a respective one of the transport envelopes in a respective one of the transport modes, the method comprises operating the one or more artificial intelligence models to determine that the respective metric fails to meet a criterion.

14. The method of claim 13, wherein:
to determine the prediction for the respective transport mode in response to the respective metric failing to meet the criterion, the method comprises operating the one or more artificial intelligence models to:
define at least a maximum clearance window along at least one of the respective transport routes having the respective metric closest to meeting the criterion; and
determine at least one alternative transport as a replacement to transport the load to match the maximum clearance window; and
to perform the dual-mode constraint analysis, the method comprises operating the one or more artificial intelligence models to use the at least one alternative transport.

15. The method of claim 13, wherein:
to determine the comparative recommendation in response to the respective metric failing to meet the criterion, the method comprises operating the one or more artificial intelligence models to discover at least one alternate transport route as a replacement; and
to perform the dual-mode constraint analysis, the method comprises operating the one or more artificial intelligence models to use the at least one alternate transport route.

16. The method of claim 1, wherein to determine a respective one of the metrics characterizing a respective one of the transport envelopes in a respective one of the transport modes, the method comprises operating the one or more artificial intelligence models to determine that the respective metric of at least one of the transport routes of the respective transport mode meets a criterion; and wherein to perform the dual-mode constraint analysis, the method comprises operating the one or more artificial intelligence models to use of the at least one transport route.

17. The method of claim 1, wherein operating the one or more artificial intelligence models comprises at least utilizing one or more of:
a first model trained to determine dimensions from image data and to calculate the respective transport envelopes from the dimensions;
a second model trained to find optimal paths along the respective transport routes; and
a third model trained to predict clearance based on an analysis of the requirement information, the respective transport envelopes, and the optimal paths.

18. The method of claim 1, wherein to determine the dimensional parameters, the method comprises operating the one or more artificial intelligence models to extract, using at least one of a transform and a language model, one or more dimension values of at least the load from one or more of tabular information, textual information, and visual depictions in one or more schematic drawings of the schematic information.

19-20. (canceled)

21. The method of claim 1, wherein:
the first transport mode is a railway transport mode, whereby the transport routes for the railway transport are railway routes and the transport is a railcar; and
the second transport mode is a roadway transport mode, whereby the transport routes are trucking routes and the transport is a trucking arrangement.

22. The method of claim 21, wherein the method comprises operating the one or more artificial intelligence models to obtain (iv) one or more guidelines at least associated with one or more railways for the railway routes; and wherein operating the one or more artificial intelligence models comprises using the one or more guidelines to determine the metrics for the railway transport mode.

23. The method of claim 21, wherein the prediction for the railway transport mode comprises a compatibility of the load with rail infrastructure; and wherein prediction for the roadway transport mode comprises a probability of highway permit approval.

24. The method of claim 21, wherein to define the transport envelopes, the method comprises operating the one or more artificial intelligence models to:
analyze physical dimensions of the load against both rail loading gauge profiles and highway bridge clearance envelopes;
process rail infrastructure constraints including track gauge compatibility and intermodal terminal capabilities; and
integrate highway permit workflow requirements including escort specifications and route restrictions.

25-29. (canceled)

30. A non-transitory machine-readable medium, on which are stored instructions for a machine, comprising instructions that when executed cause the machine to perform the method according to claim 1.

31. A system comprising:
one or more interfaces; and
one or more processors operatively couped to the one or more interfaces,
the one or more processors being configured to obtain input data with the one or more interfaces, the input data at least including (i) schematic information associated with a load to be transported, and (ii) requirement information associated with transport routes for each of a plurality of transport modes, a first of the transport modes being different from a second of the transport modes,
the one or more processors being configured to operate one or more artificial intelligence models to:
determine dimensional parameters associated with the load based on the schematic information;
define, based on the dimensional parameters, a transport envelope of the load carried on a transport for each of the first and second transport modes;
determine, for each of the first and second transport modes, a metric characterizing the transport envelope in relation to the requirement information associated with the transport routes;
determine, based on the metrics, predictions for the transport envelope to clear the requirement information associated with the transport routes for each of the first and second transport modes;
perform dual-mode constraint analysis comparing the first transport mode versus the second transport mode based on the predictions to generate a comparative recommendation; and
output the comparative recommendation.
